(19) United States
(12) Patent Application Publication
(10) Pub. No.: US 2014/0060506 A1
(43) Pub. Date: Mar. 6, 2014

(54) OXYGEN FRACTION ESTIMATION FOR DIESEL ENGINES UTILIZING VARIABLE INTAKE VALVE ACTUATION

(71) Applicant: Purdue Research Foundation, Indianapolis, IN (US)

(72) Inventor: Gregory M. Shaver, Lafayette, IN (US)

(73) Assignee: Purdue Research Foundation, Indianapolis, IN (US)

(21) Appl. No.: 14/016,843

(22) Filed: Sep. 3, 2013

Related U.S. Application Data
(60) Provisional application No. 61/695,672, filed on Aug. 31, 2012.

(51) Int. Cl. F02D 41/00

(52) U.S. Cl. CPC F02D 41/00
USPC 123/672

(57) ABSTRACT

A physically-based, generalizable method to estimate the in-cylinder oxygen fraction from production viable measurements or estimates of exhaust oxygen fraction, fresh air flow, charge flow, fuel flow, turbine flow and EGR flow. The oxygen fraction estimates can be sensitive to errors in the EGR and turbine flow, and in other embodiments, a high-gain observer is implemented to improve the estimate of EGR flow. The observer is applicable to engines utilizing high pressure cooled exhaust gas recirculation, variable geometry turbocharging and flexible intake valve actuation as well as other engines.

### CROSS REFERENCE TO RELATED APPLICATION

This application claims the benefit of priority to U.S. Provisional Patent Application Ser. No. 61/695,672, filed Aug. 31, 2012, incorporated herein by reference.

### FIELD OF THE INVENTION

Various embodiments herein pertain to internal combustion engines, and in particular some embodiments pertain to the estimation of one or more gaseous constituents within a cylinder prior to combustion.

### BACKGROUND OF THE INVENTION

Worldwide emissions regulations are becoming increasingly more stringent while consumers are demanding higher fuel efficiency. Advanced combustion strategies hold promise to satisfy both constraints. These combustion strategies, such as pre-mixed charge compression ignition (PCCI), homogenous charge compression ignition (HCCI) and low temperature combustion (LTC), are controlled and enabled through the use of flexible valve trains. Under laboratory test bed conditions, these strategies offer improvements in emission reductions while increasing or maintaining fuel efficiency. The control of these strategies requires authority over the inputs governing the combustion event, including the in-cylinder oxygen fraction. Unfortunately, no production viable in-cylinder oxygen fraction measurement is possible. Fortunately, the oxygen fractions in the intake and exhaust manifold can be utilized to calculate the in-cylinder oxygen fraction.

What is described herein are novel and nonobvious methods and apparatus for improving the control of internal combustion engines.

### SUMMARY OF THE INVENTION

Various aspects of some embodiments of the present invention pertain to methods and apparatus for estimating the quantity of oxygen in a cylinder of an internal combustion engine prior to the initiation of combustion. This estimated quantity of oxygen can be useful in the control of the engine.

Yet other aspects of some embodiments pertain to methods and apparatus for predicting the flow dynamics of gases within an intake system. These flow dynamics can be affected by the operation of a variably actuatable intake valve, as well as the supply of fresh air and the supply of recirculated exhaust gas.

Still further aspects of some embodiments pertain to the estimation of the flow dynamics within an exhaust system. In some embodiments, these flow dynamics take into account the presence of a turbocharger having a turbine including variable geometry.

Yet other aspects pertain to an estimator is developed to estimate the in-cylinder oxygen fraction from estimates of the oxygen fraction in the intake and exhaust manifolds, fresh air flow, charge flow, fuel flow, turbine flow and EGR flow. The oxygen content in the exhaust manifold can be determined utilizing the manifold filling dynamics of the exhaust manifold and Universal Exhaust Gas Oxygen (UEGO) sensor in the exhaust pipe. Some embodiments include the placement of the UEGO sensor in the exhaust pipe which shields the sensor from the more volatile conditions in the exhaust manifold. The oxygen content in the intake manifold is found based upon the manifold filling dynamics. The intake oxygen fraction estimate can be sensitive to errors in the mass flows of the manifold filling dynamics. The intake manifold filling dynamics include two input flows, fresh air and exhaust gas recirculation (EGR), and one output flow, charge flow into the cylinders. To improve the EGR flow estimate, a high-gain observer based upon the pressure dynamics is implemented to provide a more accurate EGR flow estimate.

Exponential stability of the in-cylinder oxygen fraction estimator is shown through the application of Lyapunov theory and physical knowledge of the system. The observer preferably estimates the oxygen fractions to within about one-half percent O₂ and is also shown to have exponential convergence with a time constant less than about fifty milliseconds seconds, even in the presence of turbine flow errors of up to 25%. The observer is validated on an engine utilizing high pressure cooled exhaust gas recirculation, variable geometry turbocharging and flexible intake valve actuation. Measurements or calculations of oxygen fraction are available for the intake and exhaust manifold in the form of an UEGO sensor in the exhaust pipe and laboratory grade CO2 concentration measurements in the manifolds. Since the in-cylinder mass can originate from the gas that occupies the intake and exhaust manifolds, knowledge of the manifold oxygen fractions coupled with charge and residual in-cylinder mass allow the straightforward calculation of in-cylinder oxygen fraction. However, estimates of the charge and residual in-cylinder mass is helpful since the calculation in some embodiments is essentially open-loop. In other embodiments, in-cylinder contributory masses are provided through the application of a physically-based volumetric efficiency model that captures the effects of manifold conditions and flexible intake valve actuation.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

FIG. 1 provides a schematic of a modern diesel engine according to one embodiment of the present invention.

FIG. 2A provides O₂ estimator model inputs, states and outputs.

FIG. 2B provides a block schematic representation of an algorithm according to one embodiment of the present invention.

FIG. 2C provides a block schematic representation of an algorithm according to one embodiment of the present invention.

FIG. 2D provides a block schematic representation of an algorithm according to one embodiment of the present invention.

FIG. 2E provides equation 9.

FIG. 3 provides

$${k}_{im} [ \frac{1}{kg} ]$$

over an engine operating range.

FIG. 4 provides

$${k}_{em} [ \frac{1}{kg} ]$$

over an engine operating range.

FIG. 5 provides

$${W}_{e} [ \frac{kg}{s} ]$$

over an engine operating range.

FIG. 6 provides g[%] over an engine operating range.

FIG. 7 provides τ[s] over an engine operating range.

FIG. 8 provides

$$δ [ \frac{kg}{s} ]$$

over an engine operating range.

FIG. 9 provides

$${W}_{t} [ \frac{kg}{s} ]$$

over an engine operating range.

FIG. 10 provides

$${k}_{em} δ [ \frac{1}{s} ]$$

over an engine operating range.

FIG. 11 provides engine operating conditions for various tests described herein.

FIGS. 12A, 12B, 12C and 12D provide intake oxygen percentage, exhaust oxygen percentage, flow rate, & position data as a function of time for one embodiment of oxygen estimator performance during an EGR/VGT step at 2300 rpm and 522 N-m, with FIGS. A & B also showing estimator gain.

FIGS. 13A, 13B, 13C and 13D provide intake oxygen percentage, exhaust oxygen percentage, flow rate, & position data as a function of time for one embodiment of oxygen estimator performance during an EGR/VGT step at 1850 rpm and 407 N-m, with FIGS. A & B also showing estimator gain.

FIGS. 14A, 14B, 14C and 14D provide intake oxygen percentage, exhaust oxygen percentage, flow rate, & position data as a function of time for one embodiment of oxygen estimator performance during an EGR/VGT step at 1000 rpm and 203 N-m, with FIGS. A & B also showing estimator gain.

FIGS. 15A, 15B, 15C and 15D provide intake oxygen percentage, exhaust oxygen percentage, flow rate, & position data as a function of time for one embodiment of oxygen estimator performance during an IVC step at 1000 rpm and 203 N-m, with FIGS. A & B also showing estimator gain.

FIG. 16 provides an EGR flow comparison during an EGR/VGT step at 1850 rpm and 407 N-m.

FIG. 17 provides an EGR flow estimation scheme block diagram.

FIG. 18 provides O₂ and EGR flow estimator model inputs, states and outputs.

FIGS. 19A, 19B, 19C and 19D provide intake oxygen percentage, exhaust oxygen percentage, flow rate, & position data as a function of time for one embodiment of oxygen estimator performance during an EGR/VGT step at 2300 rpm and 522 N-m, with FIGS. A & B also showing estimator gain.

FIGS. 20A, 20B, 20C and 20D provide intake oxygen percentage, exhaust oxygen percentage, flow rate, & position data as a function of time for one embodiment of oxygen estimator performance during an EGR/VGT step at 1850 rpm and 407 N-m, with FIGS. A & B also showing estimator gain.

FIGS. 21A, 21B, 21C and 21D provide intake oxygen percentage, exhaust oxygen percentage, flow rate, & position data as a function of time for one embodiment of oxygen estimator performance during an EGR/VGT step at 1000 and 203 N-m, with FIGS. A & B also showing estimator gain.

FIGS. 22A, 22B, 22C and 22D provide intake oxygen percentage, exhaust oxygen percentage, flow rate, & position data as a function of time for one embodiment of oxygen estimator performance during an IVC step at 1000 rpm 203 N-m, with FIGS. A & B also showing estimator gain.

FIGS. 23A, 23B, 23C and 23D provide intake oxygen percentage, exhaust oxygen percentage, flow rate, & V of the Lyapounov function versus time for one embodiment of oxygen estimator performance during an EGR/VGT step at 2300 rpm and 522 N-m, with FIGS. A & B also showing estimator gain.

FIGS. 24A, 24B, 24C and 24D provide intake oxygen percentage, exhaust oxygen percentage, flow rate, & V of the Lyapounov function versus time for one embodiment of oxygen estimator performance during an EGR/VGT step at 1850 rpm and 407 N-m, with FIGS. A & B also showing estimator gain.

FIGS. 25A, 25B, 25C and 25D provide intake oxygen percentage, exhaust oxygen percentage, flow rate, & V of the Lyapounov function versus time for one embodiment of oxygen estimator performance during an EGR/VGT step at 1000 rpm and 203 N-m, with FIGS. A & B also showing estimator gain.

FIGS. 26A, 26B, 26C and 26D provide intake oxygen percentage, exhaust oxygen percentage, flow rate, & V of the Lyapounov function versus time for one embodiment of oxygen estimator performance during an IVC step at 1000 rpm and 203 N-m, with FIGS. A & B also showing estimator gain.

### ELEMENT NUMBERING

The following is a list of element numbers and at least one noun used to describe that element. It is understood that none of the embodiments disclosed herein are limited to these nouns, and these element numbers can further include other words that would be understood by a person of ordinary skill reading and reviewing this disclosure in its entirety.

| | |
|---|---|
| 10 | engine |
| 12 | EGR loop |
| 13 | exhaust manifold |
| 14 | variable geometry turbocharger |
| 15 | turbine |
| 16 | intake manifold |
| 17 | combustion chamber |
| 18 | electronic control module |
| 19 | variable (flexible) intake valve |
| 20 | sensor |
| 22 | fuel system |
| 24 | EGR cooler |
| 26 | actuatable EGR valve |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims. The usage of words indicating preference, such as “preferably,” refers to features and aspects that are present in at least one embodiment, but which are optional for some embodiments.

Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise explicitly noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

What will be shown and described herein, along with various embodiments of the present invention, is discussion of one or more tests that were performed. It is understood that such examples are by way of example only, and are not to be construed as being limitations on any embodiment of the present invention. Further, it is understood that embodiments of the present invention are not necessarily limited to or described by the mathematical analysis presented herein.

Various references may be made to one or more processes, algorithms, operational methods, or logic, accompanied by a diagram showing such organized in a particular sequence. It is understood that the order of such a sequence is by example only, and is not intended to be limiting on any embodiment of the invention.

What will be shown and described herein are one or more functional relationships among variables. Specific nomenclature for the variables may be provided, although some relationships may include variables that will be recognized by persons of ordinary skill in the art for their meaning. For example, “t” could be representative of temperature or time, as would be readily apparent by their usage. However, it is further recognized that such functional relationships can be expressed in a variety of equivalents using standard techniques of mathematical analysis (for instance, the relationship F=ma is equivalent to the relationship F/a=m). Further, in those embodiments in which functional relationships are implemented in an algorithm or computer software, it is understood that an algorithm-implemented variable can correspond to a variable shown herein, with this correspondence including a scaling factor, control system gain, noise filter, or the like.

Various embodiments of the present invention pertain to apparatus and methods related to the operation of an internal combustion engine, such as a diesel engine. Various embodiments include algorithms useful in a control system. These algorithms calculate or estimate the physical state of the engine during operation, with these estimations and calculations being useful in the ultimate control of the engine. For example, algorithms will be described that predict or estimate the flow characteristics (flows of both gases and liquids such as fuels) within a manifold system, such as an intake 16 or exhaust 13 manifold. With knowledge of such manifold flow characteristics, various embodiments include the prediction or estimation of the quantity of oxygen available in the engine's combustion chamber 17 prior to the combustion event.

Various embodiments of the present invention provide a prediction or estimation of the quantity of gaseous oxygen within the combustion chamber. A mixture of gases flows out of the intake manifold and into the combustion chamber, where it is combined with fuel to create a combustible charge. In those embodiments including the recirculation of exhaust gas (to limit oxides of nitrogen), it is recognized that the gas within the intake manifold includes both fresh air containing a particular quantity of oxygen, and exhaust gas containing a different quantity of oxygen. The quantity of oxygen in the exhaust gas is estimated with an algorithm that includes data corresponding to a measurement of oxygen in the exhaust gas made with a wide band oxygen sensor. Preferably, in some embodiments, this sensor is placed downstream of the exhaust manifold to a location where there has been sufficient residence time for a reduction in any combusted components that were still volatile after exiting the combustion chamber.

Some embodiments include an estimation of the flow characteristics of an intake system preferably including both a manifold and an intake valve capable of variable operation under the control of an electronic computer. This estimation can be useful in the prediction of a quantity of oxygen available in the combustion chamber prior to combustion. Preferably, the operation of the intake valve can be varied over a range of valve operational parameters, including but not limited to valve opening time, valve closing time, valve lift, valve lift rate, or any other aspect of valve actuation. The variable operation of the valve can affect the filling dynamics of the intake manifold, since the valve operational parameters such as opening and closing times and lift affect the flow of gases out of the intake manifold and into the combustion chambers. Further, although various tests have been run on an engine using a poppet valve, it is understood that yet other embodiments of the present invention are not so limited, and contemplate the use of any type of valve suitable for operation with an internal combustion engine.

Yet other embodiments of the present invention include one or more algorithms that predict or estimate the quantity of oxygen being provided to the combustion chamber by taking into account the dynamics of the exhaust system. In some embodiments, the exhaust system includes one or more components that directly affect the state of the exhaust gas. These components include turbochargers, with or without variable geometry, exhaust coolers 24, and actuatable EGR valves 26. In some embodiments, the turbocharger includes a variable turbine nozzle that is actuatable by the electronic controller. It is further understood that the turbocharger can include other variable features, including variable geometry associated with the compressor, a waste gate, and the like. The exhaust system can further include EGR heat exchangers, whether air-cooled or water-cooled. Still further, the EGR valve can be actuatable in various modes, including on-off control, or variable flow over a range of actuation. It is understood that any combination of these components can affect the state of the exhaust gas, which is a factor in the quantity of exhaust gas that is recirculated into the intake manifold, and which further is a factor in the quantity of oxygen provided in the combustion chamber. Various embodiments further contemplate algorithms for estimating or predicting the quantity of oxygen in the charge of gases within the combustion chamber by accounting for the amount fuel being provided to the combustion chamber.

Yet other embodiments account for the interaction of the intake manifold 16 filling dynamics and exhaust manifold 13 filling dynamics on the quantity of oxygen being provided to the combustion chamber. As one example, variation in the operation of an actuatable intake valve will affect the gas pressure within the intake manifold, which serves as a back pressure to the flow of recirculated exhaust gas exiting an EGR valve. Yet further embodiments recognize that the inlet conditions to the EGR valve are likewise a function of exhaust manifold filling dynamics, these dynamics being affected by the presence of turbochargers, exhaust coolers, and other exhaust gas-flowing devices. Some embodiments account for and assist in providing estimates of EGR flow by way of yet other algorithms that include observations of the various engine components to assist the prediction of exhaust gas flow into the intake manifold. In some embodiments, these observations are used in a high-gain algorithm that quickly establishes an estimate of recirculated exhaust gas flow.

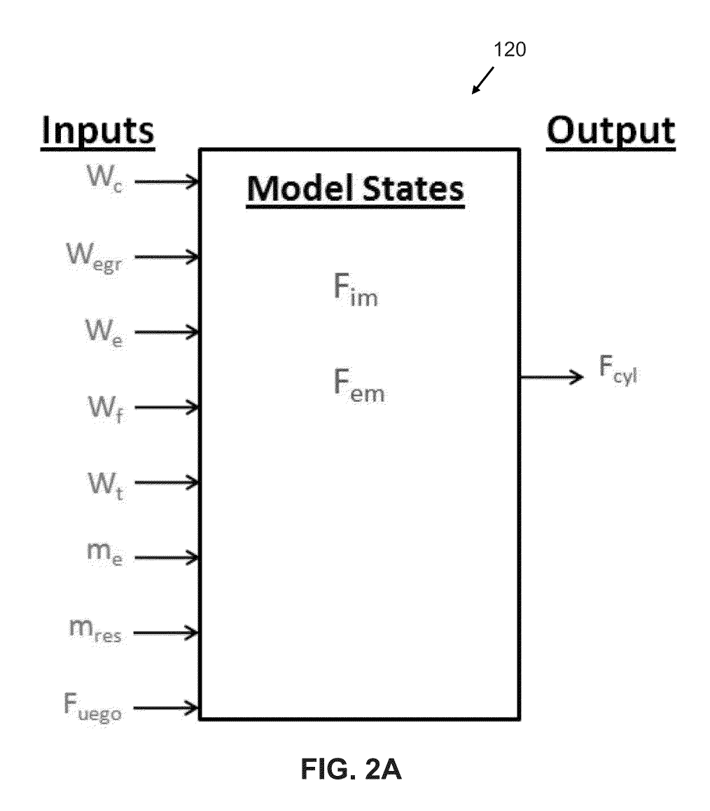

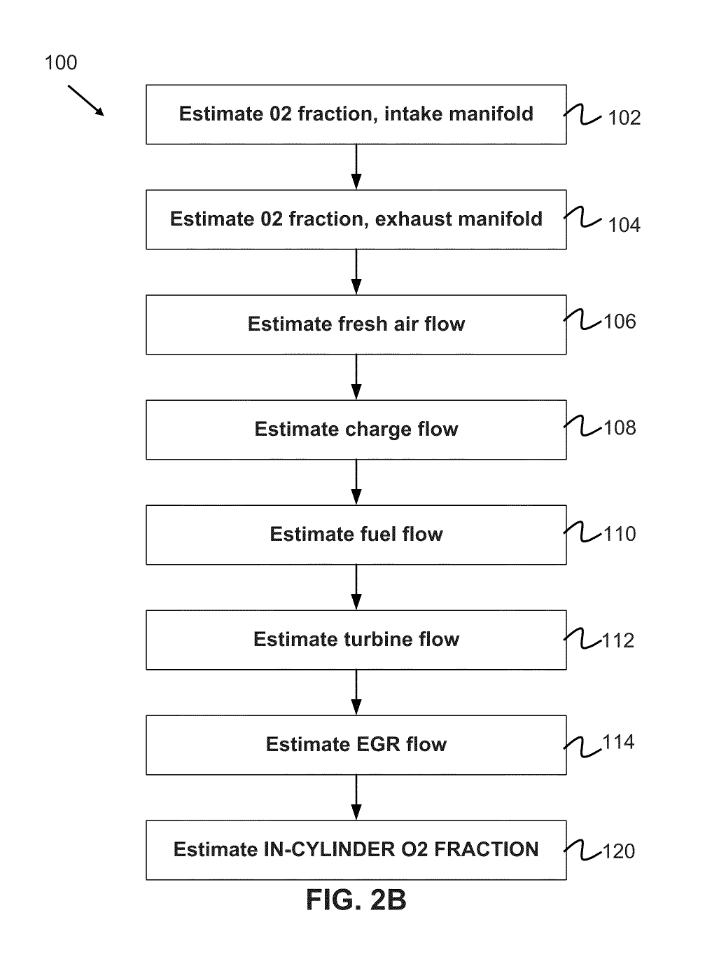

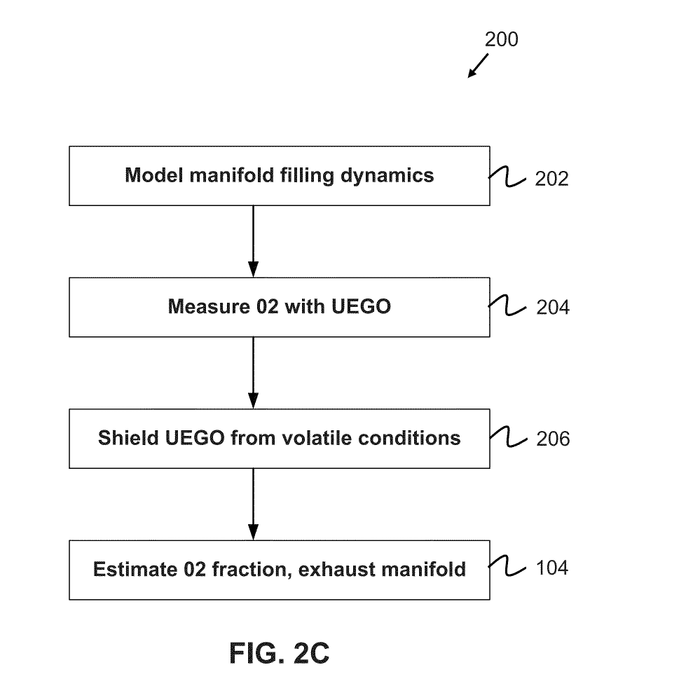

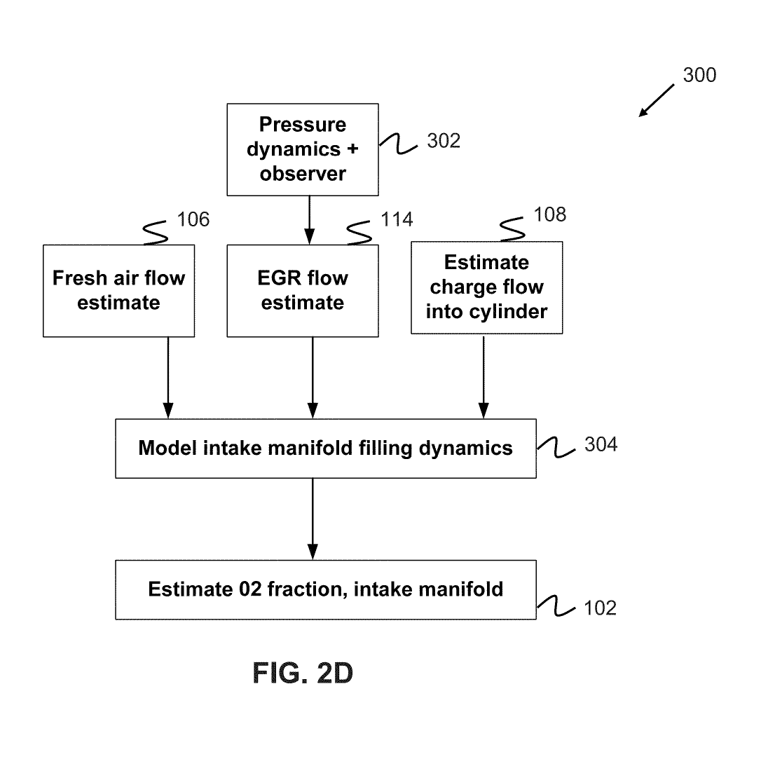

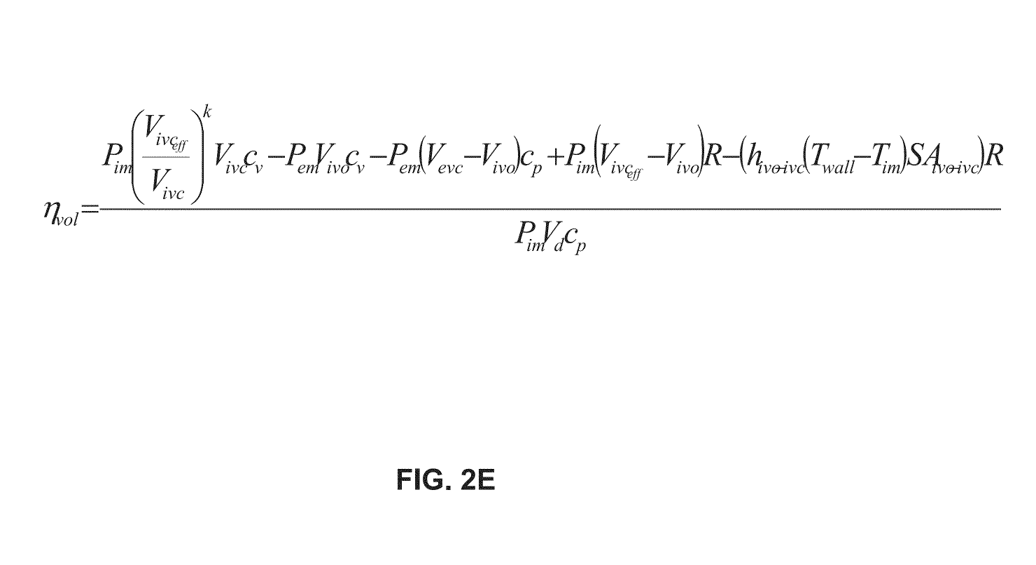

In one embodiment, an estimator is developed to estimate the in-cylinder oxygen fraction from estimates of the oxygen fraction in the intake and exhaust manifolds, fresh air flow, charge flow, fuel flow, turbine flow and EGR flow (see FIG. 2B). The oxygen content in the exhaust manifold can be determined utilizing the manifold filling dynamics of the exhaust manifold and Universal Exhaust Gas Oxygen (UEGO) sensor in the exhaust pipe (see FIG. 2C). Some embodiments include the placement of the UEGO sensor in the exhaust pipe which shields the sensor from the more volatile conditions in the exhaust manifold. The oxygen content in the intake manifold is found based upon the manifold filling dynamics. The intake oxygen fraction estimate can be sensitive to errors in the mass flows of the manifold filling dynamics. The intake manifold filling dynamics include two input flows, fresh air and exhaust gas recirculation (EGR), and one output flow, charge flow into the cylinders (see FIG. 2D). To improve the EGR flow estimate, a high-gain observer based upon the pressure dynamics is implemented to provide a more accurate EGR flow estimate.

Exponential stability of the in-cylinder oxygen fraction estimator is shown through the application of Lyapunov theory and physical knowledge of the system. The observer preferably estimates the oxygen fractions to within about one-half percent O₂ and is also shown to have exponential convergence with a time constant less than about fifty milliseconds seconds, even in the presence of turbine flow errors of up to 25%. The observer is validated on an engine utilizing high pressure cooled exhaust gas recirculation, variable geometry turbocharging and flexible intake valve actuation. Measurements or calculations of oxygen fraction are available for the intake and exhaust manifold in the form of an UEGO sensor in the exhaust pipe and laboratory grade CO₂ concentration measurements in the manifolds. Since the in-cylinder mass can originate from the gas that occupies the intake and exhaust manifolds, knowledge of the manifold oxygen fractions coupled with charge and residual in-cylinder mass allow the straightforward calculation of in-cylinder oxygen fraction. However, estimates of the charge and residual in-cylinder mass is helpful since the calculation in some embodiments is essentially open-loop. In other embodiments, in-cylinder contributory masses are provided through the application of a physically-based volumetric efficiency model that captures the effects of manifold conditions and flexible intake valve actuation.

In-cylinder oxygen fraction is helpful to the promotion and control of advanced combustion strategies. No direct measurement of in-cylinder oxygen fraction is available on production engines. In one embodiment, an in-cylinder oxygen fraction estimator was developed based upon a two-state linear parameter-varying model of the oxygen fraction dynamics and a measurement of oxygen fraction in the exhaust (post turbine) from an UEGO sensor. A high-gain observer was developed and implemented to improve the EGR flow estimate and improve the oxygen fraction predictions. The estimator provides oxygen fraction estimates for both the intake and exhaust manifolds which can then be used to calculate the in-cylinder oxygen fraction.

A proof of the stability of the estimator was demonstrated utilizing Lyapunov theory to show estimator error convergence toward zero. Exponential stability was also shown in the presence of a bounded uncertainty on the turbine flow. Experimental validation results were presented from an unique test bed of a turbocharged diesel engine equipped with a VVA system. The experimental results validate the utility of the model and demonstrate that the observer estimates the oxygen fractions to within 0.5% O₂ and converges with a time constant less than 0.05 seconds.

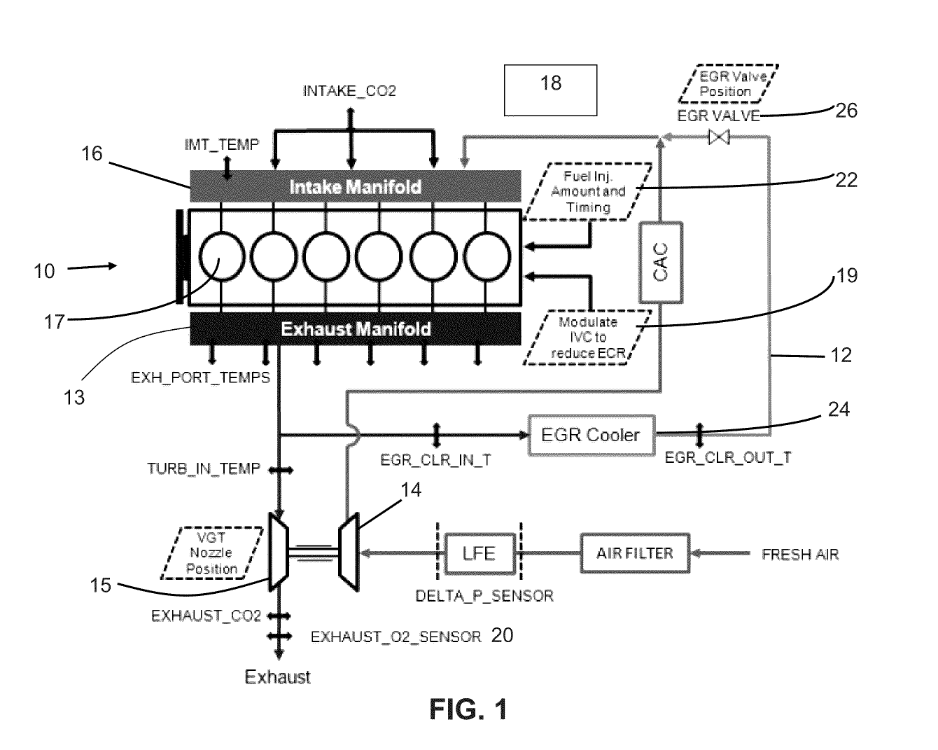

The engine test bed utilized for experimental validation according to some embodiments of the present invention is a Cummins ISB diesel engine. As shown in FIG. 1, the ISB engine 10 is an I6 (in-line six-cylinder) configuration with a displacement of 6.7 liters and rated at 350 brake horsepower. The 2008 engine is equipped with a cooled high-pressure exhaust gas recirculation (EGR) loop 12 and a variable geometry turbocharger (VGT) 14 for emissions control. This test bed includes an electro-hydraulic variable valve actuation (VVA) system 16 allowing cylinder-independent, cycle-to-cycle control of the intake valve pairs. A dSPACE system collects the experimental validation data, controls the WA system and manages the test cell operation. Data from the engine electronic control module (ECM) 18, such as the fuel injection timing and quantity commands as well as stock sensor measurements is recorded by the dSPACE system in addition to complementary temperature, pressure, flow and emissions measurements instrumented on the engine test bed. Fresh air mass flow rate is measured using a laminar flow element (LFE) device. Emission gas analyzers are used to measure the composition of the exhaust gases as well as the concentration of CO₂ in the intake manifold. Cambustion NDIR Fast CO₂ analyzers were utilized during this testing. The intake manifold CO₂ is sampled in three locations and averaged to provide the best measurement average of the true intake manifold CO₂, as shown in FIG. 1. An UEGO sensor 20 is mounted in the exhaust pipe shortly after the turbine outlet as shown in FIG. 1.

The manifold filling dynamics are utilized to derive the oxygen fraction dynamics for the control-oriented model. A similar model for air fraction dynamics in a dual-loop EGR system is developed. The oxygen fraction dynamics are shown in Eqs. 1 and 2. In Eqs. 1 and 2 the fraction terms appear linearly in the dynamics.

$$\begin{matrix}{\dot{F}}_{im} = \frac{{RT}_{im}}{{P}_{im} {V}_{im}} [ {F}_{amb} {W}_{c} + {F}_{em} {W}_{egr} - {F}_{im} {W}_{e} ] & ( 1 ) \\ {\dot{F}}_{em} = \frac{{RT}_{em}}{{P}_{em} {V}_{em}} [ {F}_{eo} ( {W}_{e} + {W}_{f} ) - {F}_{em} {W}_{egr} - {F}_{em} {W}_{t} ] & ( 2 )\end{matrix}$$

In Eq. 1, W_{c} is the fresh air flow from the turbocharger compressor. W_{egr} is the EGR flow from the exhaust manifold and is measured on the engine through the use of a calibrated orifice and a delta pressure measurement across the orifice. Wₑ is the charge flow from the intake manifold into the engine cylinders. F_{amb} is the ambient oxygen fraction and is a function of the humidity level. Fᵢₘ is the oxygen fraction in the intake manifold 16 and Fₑₘ is the oxygen fraction in the exhaust manifold 13. In Eq. 2, Wₜ is the flow from the exhaust manifold through the turbocharger turbine. W_{f} is the fuel rate flow into the cylinders. Fₑₒ is the oxygen fraction of the gas leaving the cylinder. Fₑₒ is calculated based on a chemical balance of diesel fuel (C₁₂H₂₃) reacted with the in-cylinder oxygen to major products of CO₂, H₂O and O₂ as shown in Eq. 3 where F_{cyl} is the trapped oxygen fraction in-cylinder from the incoming charge gas and remaining residual gas, F_{f} is the molar fuel fraction and Fₑₒ is the oxygen fraction after combustion based upon the chemical balance. me is the trapped charge mass and mᵣₑₛ is the residual mass due to trapping and back-flow from the exhaust manifold. The resulting simplified expression for Fₑₒ is shown in Eq. 7.

$$\begin{matrix}{F}_{f} {C}_{12} {H}_{23} + {F}_{cyl} {O}_{2} -> 12 {F}_{f} C {O}_{2} + \frac{23}{2} {F}_{f} {H}_{2} O + {F}_{eo} {O}_{2} & ( 3 ) \\ {F}_{cyl} = \frac{{m}_{e} \cdot {F}_{im} + {m}_{res} \cdot {F}_{em}}{{m}_{e} + {m}_{res}} & ( 4 ) \\ {m}_{e} = \frac{{W}_{e} \cdot 120}{N} & ( 5 ) \\ {m}_{res} = \frac{{P}_{em} \cdot {V}_{evc}}{R \cdot {T}_{em}} & ( 6 ) \\ {F}_{eo} = {F}_{cyl} - \frac{71}{4} {F}_{f} & ( 7 )\end{matrix}$$

The fresh air flow, W_{c}, is measured using a LFE device as a surrogate for a mass air flow sensor. The charge flow, Wₑ, is calculated using the speed-density equation, shown in Eq. 8:

$${W}_{e} = \frac{{η}_{vol} \cdot {P}_{im} \cdot {V}_{d}}{R \cdot {T}_{im}} \qquad ( 8 )$$

V_{d} is the swept displacement of the engine. Pᵢₘ and Tᵢₘ are the measured pressure and temperature in the intake manifold respectively. The physically-based volumetric efficiency model is shown in Eq. 9 (see FIG. 2E) and is a function of the manifold conditions and the effective compression ratio. In Eq. 9, Vₓ is the volume at x where x is a particular crank angle event such as the intake valve closing (ivc), intake valve opening (ivo) or effective intake valve closing (iv_{ceff}). cᵥ and cₚ are the specific heats, R is the gas constant and k is the polytropic compression coefficient. H_{ivo-ivc} is the heat transfer coefficient, T_{wall} is the cylinder wall temperature and SAi_{vo-ivc} is the surface area time.

W_{f} is the fuel rate and is taken from the ECM. The variable geometry turbocharger 14 turbine 15 is modeled using analytical functions based upon turbine maps provided by the turbocharger manufacturer to determine the flow through the turbine. Turbine maps generally express turbine speed and mass flow in terms of reduced quantities to account for inlet conditions:

$$\begin{matrix}{W}_{t , red} = \frac{{W}_{t } \sqrt{{T}_{em}}}{{P}_{em}} & ( 10 ) \\ {ω}_{tc , red} = \frac{{ω}_{tc}}{\sqrt{{T}_{em}}} & ( 11 )\end{matrix}$$

where Tₑₘ and Pₑₘ are the turbine inlet temperature and pressure.

The turbine flow, Wₜ, is calculated using the pressure ratio across the turbine, PRₜ, and the turbocharger shaft speed,

[symbol]

as shown in Eq. 12.

$${W}_{t} = π {{d}_{t}^{2} ( γ {R}_{exh} )}^{\frac{1}{2 γ}} [ {b}_{1} + {b}_{2} \sqrt{\frac{2 {c}_{p , exh} ( 1 - {PR}_{t}^{\frac{1 - γ}{γ}} )}{{( \frac{π}{60} {d}_{t} {ω}_{tc , red} )}^{2}}} ] \times \frac{( {α}_{1} {X}_{VGT}^{2} + {α}_{2} {X}_{VGT} + {α}_{3} ) {( \frac{π}{60} {d}_{t} {ω}_{tc , red} )}^{\frac{2 γ - 1}{γ}}}{4 {R}_{exh} \sqrt{2 {c}_{p , exh} ( 1 - {PR}_{t}^{\frac{1 - γ}{γ}} )}} \qquad ( 12 )$$

Here, Rₑₓₕ and C_{p,exh} are assumed to be constant. The values for bᵢ and α₁, found via least squares, are listed in Table I. Note that the three inputs to Eq. 12 are ω_{tc,red,}PRₜ and X_{VGT}, and result in reduced mass flow. This reduced mass flow can then be used in Eq. 10 to back out actual mass flow through the turbine.

TABLE 1
TURBINE MASS FLOW CONSTANTS

| | |
|---|---|
| b₁ | −2.8883 × 10⁻² |
| b₂ | 1.9318 |
| α₁ | −1.2056 |
| α₂ | 2.2198 |
| α₃ | −1.5203 × 10⁻² |

Putting the dynamics into state-space form yields Eq. 13. The desired output of the estimator is the in-cylinder oxygen fraction which is directly expressed in Eq. 4 and utilizes the states in Eq. 13.

$$\begin{matrix}[ \begin{matrix}{\dot{F}}_{im} \\ {\dot{F}}_{em}\end{matrix} ] = [ \begin{matrix}- {k}_{im} {W}_{e} & {k}_{im} {W}_{egr} \\ 0 & - {k}_{em} ( {W}_{egr} + {W}_{t} )\end{matrix} ] [ \begin{matrix}{F}_{im} \\ {F}_{em}\end{matrix} ] + [ \begin{matrix}{k}_{im} {F}_{amb} {W}_{c} \\ {k}_{em} {F}_{eo} ( {W}_{e} + {W}_{f} )\end{matrix} ] & ( 13 ) \\ z = {F}_{em} = [ \begin{matrix}0 & 1\end{matrix} ] [ \begin{matrix}{F}_{im} \\ {F}_{em}\end{matrix} ] & ( 14 ) \\ {k}_{im} = \frac{R {T}_{im}}{{P}_{im} {V}_{im}} = \frac{1}{{m}_{im}} > 0 & ( 15 ) \\ {k}_{em} = \frac{R {T}_{em}}{{P}_{em} {V}_{em}} = \frac{1}{{m}_{em}} > 0 & ( 16 )\end{matrix}$$

The term z, shown in Eq. 14, is used in some embodiments as the oxygen fraction in the exhaust manifold since Fem is measurable via an UEGO sensor, F_{uego}, in the exhaust pipe as shown in FIG. 1. Since the UEGO sensor can be located directly after the turbine, the transport delay will be small and is therefore neglected. Equations 15 and 16 simplify the preceding expressions and physically represent the inverse of the mass trapped in the intake and exhaust manifold respectively. The system is a linear parameter-varying (LPV) system of the form shown in Eqs. 17 and 18.

ġ=A(ρ)g+W(ρ) (17)

ρ=(kᵢₘ,kₑₘ,Wₑ,W_{egr},Wₜ,W_{c},W_{f},F_{amb},Fₑₒ) (18)

Due to simplicity and ease of implementation, a Luenberger-like observer strategy was implemented for the in-cylinder oxygen fraction estimator.

$$\begin{matrix}\dot{\hat{g}} = A ( ρ ) \hat{g} + W ( ρ ) + L ( ρ ) ( z - \hat{z} ) & ( 19 ) \\ \hat{g} = [ \begin{matrix}{\hat{g}}_{im} \\ {\hat{g}}_{em}\end{matrix} ] = [ \begin{matrix}{\hat{F}}_{im} \\ {\hat{F}}_{em}\end{matrix} ] & ( 20 ) \\ {\hat{F}}_{cyl} = [ \begin{matrix}\frac{{m}_{e}}{{m}_{e} + {m}_{res}} & \frac{{m}_{res}}{{m}_{e} + {m}_{res}}\end{matrix} ] [ \begin{matrix}{\hat{F}}_{im} \\ {\hat{F}}_{em}\end{matrix} ] & ( 21 )\end{matrix}$$

A block schematic of the inputs, states and outputs of the in-cylinder oxygen fraction estimator 120 is shown graphically is FIG. 2A. FIGS. 2B, 2C, and 2D represent algorithms used in various embodiments of the present invention for implementation of some of the various data generation or control schemes disclosed herein. FIG. 2B shows an alternative block schematic of the various estimations and measurements that, in some embodiments, represent the in-cylinder oxygen fraction estimator 120. FIG. 2C is a block schematic representation 200 of various aspects including measurements, analysis, and design features that provide the estimate 104 of the oxygen fraction in the exhaust manifold. FIG. 2D provides a schematic 300 showing the various measurements, aspects, and design features that provide the estimate 102 of the oxygen fraction in the intake manifold.

The inputs to the observer 120 in some embodiments include the measured system flow, W_{c}; the calculated system flows, W_{egr}, Wₑ, W_{f} and Wₜ; the calculated in-cylinder masses, mₑ and mᵣₑₛ; and the UEGO sensor feedback, Fuego. Table II lists the source of the parameters utilized in the model. The L(ρ) gain vector is selected utilizing parameters from the system to assist exponential stability.

The estimation error dynamics can be written in a similar manner to the standard form for a Luenberger observer.

\tilde{g}=g−ĝ (22)

\tilde{ġ}=ġ−\hat{ġ}=A(ρ)(g−ĝ)−L(ρ)(z−\hat{z}) (23)

\tilde{ġ}=A(ρ)\tilde{g}−L(ρ)C\tilde{g} (24)

TABLE II
02 ESTIMATOR MODEL PARAMETERS

| | |
|---|---|
| W_{c} | measured with LFE device |
| W_{egr} | calculated by ECM |
| Wₑ | calculated from Eq. 9 |
| W_{f} | calculated by ECM |
| Wₜ | calculated from Eq. 12 |
| mₑ | calculated from Eq. 5 |
| mᵣₑₛ | calculated from Eq. 6 |
| F_{uego} | measured with UEGO |
| | sensor in exhaust pipe |

Stability of the estimation error dynamics can be shown. While the estimation error dynamics are a LPV system, at a given system operating condition, the parameters forming the ρ vector are constant. The presence of the UEGO sensor as a feedback signal provides the opportunity for robustness to uncertainty in the exhaust manifold oxygen dynamics. Wₜ flow is estimated including the part-to-part variability of the turbocharger over a population of engines. Selection of the L(ρ) gain matrix can provide robustness to uncertainty in the turbine flow. The Ag(ρ) matrix with a turbine flow uncertainty term is shown in Eq. 25, where 8 represents the uncertain flow term.

$$\begin{matrix}{A}_{δ} ( ρ ) = [ \begin{matrix}- {k}_{im} {W}_{e} & {k}_{im} {W}_{egr} \\ 0 & - {k}_{em} ( {W}_{egr} + {W}_{t} + δ )\end{matrix} ] & ( 25 ) \\ {A}_{δ} ( ρ ) = A ( ρ ) + [ \begin{matrix}0 & 0 \\ 0 & - {k}_{em} δ\end{matrix} ] & ( 26 ) \\ \dot{\hat{g}} = {A}_{δ} ( ρ ) \hat{g} + W ( ρ ) + L ( ρ ) ( z - \hat{z} ) & ( 27 )\end{matrix}$$

The estimation error dynamics can then be written for the uncertain system.

$$\begin{matrix}\tilde{g} = g - \hat{g} & ( 28 ) \\ \dot{\tilde{g}} = \dot{g} - \dot{\hat{g}} & ( 29 ) \\ \begin{matrix}\dot{\tilde{g}} = A ( ρ ) ( g - \hat{g} ) - [ \begin{matrix}0 & 0 \\ 0 & - {k}_{em} δ\end{matrix} ] \hat{g} - L ( ρ ) ( z - \hat{z} ) \\ = A ( ρ ) \tilde{g} + {k}_{em} δ {\hat{g}}_{em} - L ( ρ ) C \tilde{g} ( 31 )\end{matrix} & ( 30 )\end{matrix}$$

Consider a gain matrix, L(ρ), of the form:

$$L ( ρ ) = [ \begin{matrix}{k}_{im} {W}_{egr} \\ {k}_{im} {W}_{e} - {k}_{em} ( {W}_{egr} + {W}_{t} ) + l\end{matrix} ] . \qquad ( 32 )$$

A candidate Lyapunov function is then selected as shown in Eq. 33.

$$V = \frac{1}{2} {\tilde{g}}_{im}^{2} + \frac{1}{2} {\tilde{g}}_{em}^{2} \qquad ( 33 )$$

The candidate Lyapounov function, V, shown in Eq. 33, is positive definite. The derivative of V is shown in Eq. 34.

\dot{V}=\tilde{g}ᵢₘ\tilde{ġ}ᵢₘ+\tilde{g}ₑₘ\tilde{ġ}ₑₘ (34)

The estimation error dynamics in Eq. 31 and gain matrix (Eq. 32) are substituted into Eq. 34 resulting in Eq. 35.

$$\dot{V} = {\tilde{g}}_{im} [ - {k}_{im} {W}_{e} {\tilde{g}}_{im} + {k}_{im} {W}_{egr} {\tilde{g}}_{em} - {k}_{im} {W}_{egr} {\tilde{g}}_{em} ] + {\tilde{g}}_{em} [ - {k}_{em} ( {W}_{egr} + {W}_{t} ) {\tilde{g}}_{em} + {k}_{em} δ {\hat{g}}_{em} ] + {\tilde{g}}_{em} [ - ( {k}_{im} {W}_{e} - {k}_{em} ( {W}_{egr} + {W}_{t} ) + l ) {\tilde{g}}_{em} ] \qquad ( 35 )$$

The terms in Eq. 35 can be collected resulting in the expression shown in Eq. 36.

\dot{V}=−kᵢₘWₑ\tilde{g}ᵢₘ²−kᵢₘWₑ\tilde{g}ₑₘ²+kₑₘδĝₑₘ\tilde{g}ₑₘ−l\tilde{g}ₑₘ² (36)

The common factor—kᵢₘWₑ can be pulled out from the first two terms of Eq. 36 as shown in Eq. 37.

\dot{V}=−kᵢₘWₑ(\tilde{g}ᵢₘ²+\tilde{g}ₑₘ²)+kₑₘδĝₑₘ\tilde{g}ₑₘ−l\tilde{g}ₑₘ² (37)

Recognizing that the term in parenthesis is simply 2V from Eq. 33, yields the expression shown in Eq. 38.

\dot{V}=−2kᵢₘWₑV+kₑₘδĝₑₘ\tilde{g}ₑₘ−l\tilde{g}ₑₘ² (38)

From Eqs. 15 and 16, it is known that kᵢₘ and kₑₘ are greater than zero. When the engine is operating, Wₑ will also assume a value greater than zero. With knowledge of the value of 8, the gain l can be selected for exponential convergence of the error, with a time constant of

$$\frac{1}{2 {k}_{im} {W}_{e}} ,$$

such that:

\dot{V}≦−(2kᵢₘWₑ)V (39)

V(t)≦V(t₀)e^{-2k}^{ᵢₘ}^{W}^{ₑ} (40)

Under these conditions, \dot{}V is negative definite, since V is positive definite, it follows that the estimation errors, \tilde{g}ᵢₘ and \tilde{g}ₑₘ, will converge toward zero exponentially with time.

In order to realize the conditions in Eq. 39, the third term in Eq. 38 should satisfy

l\tilde{g}ₑₘ²>kₑₘδĝₑₘ\tilde{g}ₑₘ=kₑₘδgₑₘ\tilde{g}ₑₘ−kₑₘδ\tilde{g}ₑₘ (41)

such that:

$$l > \frac{{k}_{em} δ {g}_{em}}{{\tilde{g}}_{em}} - {k}_{em} δ . \qquad ( 42 )$$

As long as the condition of the l gain in Eq. 42 is met, the estimator error will converge toward zero exponentially with a time constant of

$$\frac{1}{2 {k}_{im} {W}_{e}}$$

(per Eq. 40). However, also note that as \tilde{g}ₑₘ (the error in the exhaust oxygen fraction estimate) approaches zero, the gain l would be required to approach ∞. For this reason, an acceptable region of attraction is selected, such that \tilde{g}ₑₘ is forced “close” to zero. For practical purposes, in some embodiments, l should satisfy:

$$l > \frac{{k}_{em} δ {g}_{em}}{0.5} - {k}_{em} δ . \qquad ( 43 )$$

Various embodiments include an assessment of values of kₑₘ, δ and gₑₘ that could be realized during engine operation at different operating points. In addition, realized values of kᵢₘ and Wₑ allow direct calculation of the exponential rate of convergence of the estimation error (per Eq. 40) under the conditions of Eq. 43.

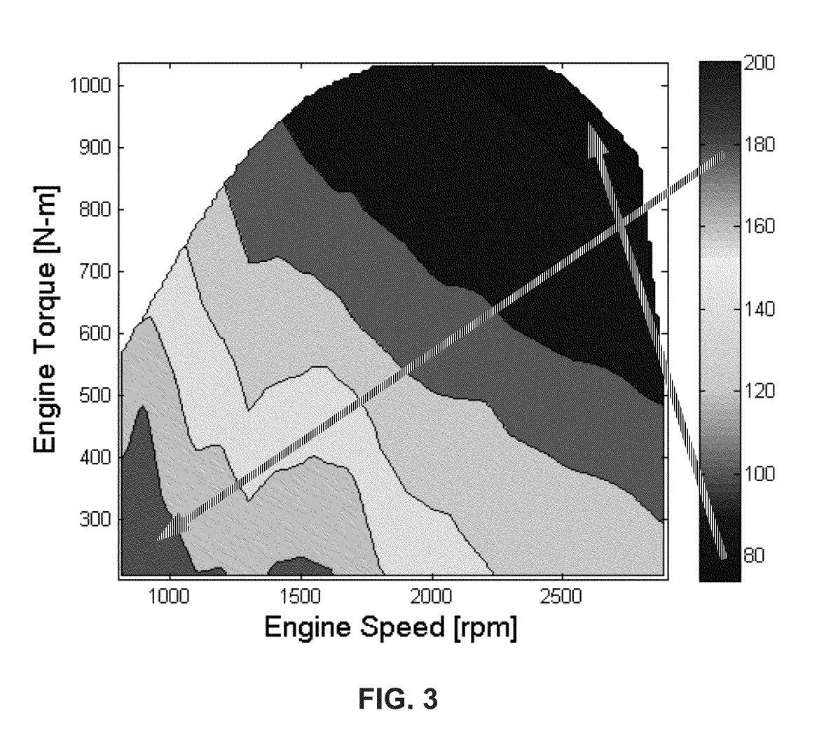

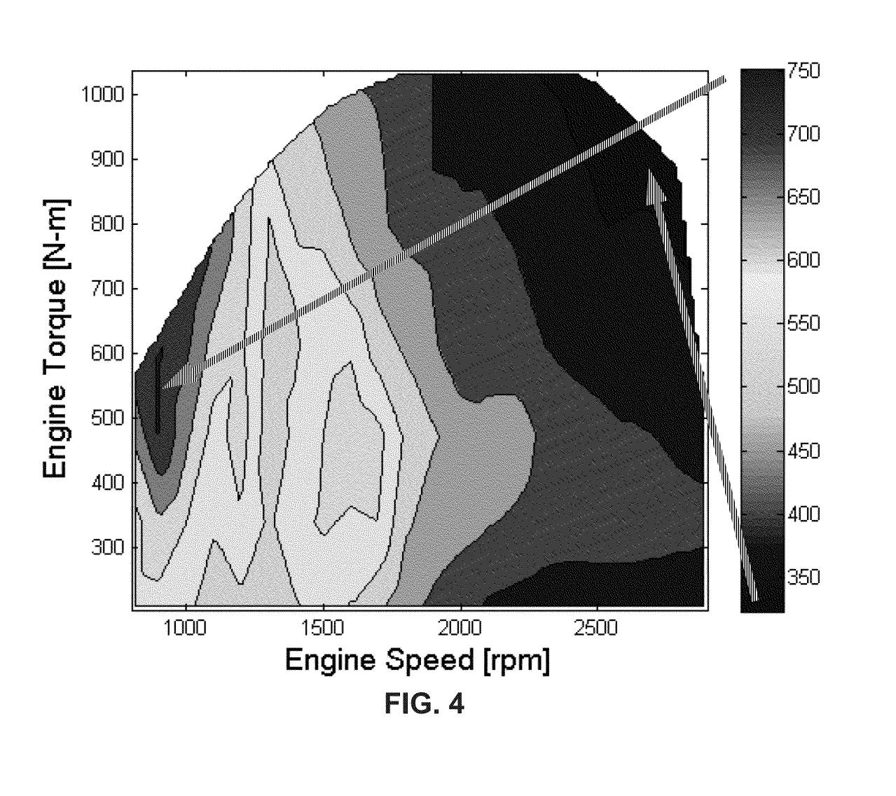

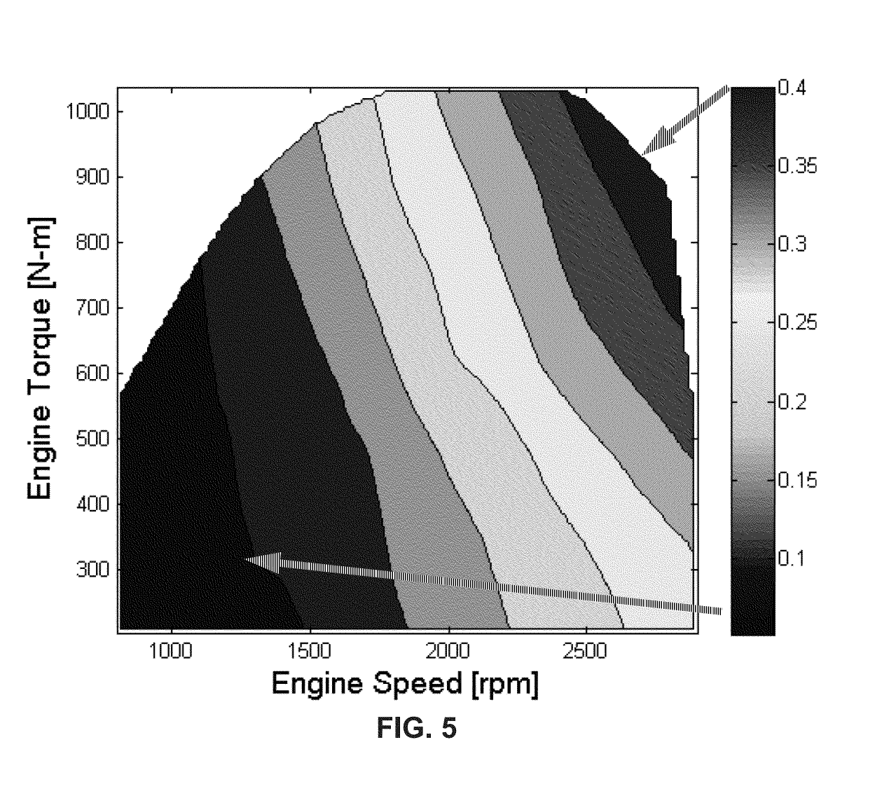

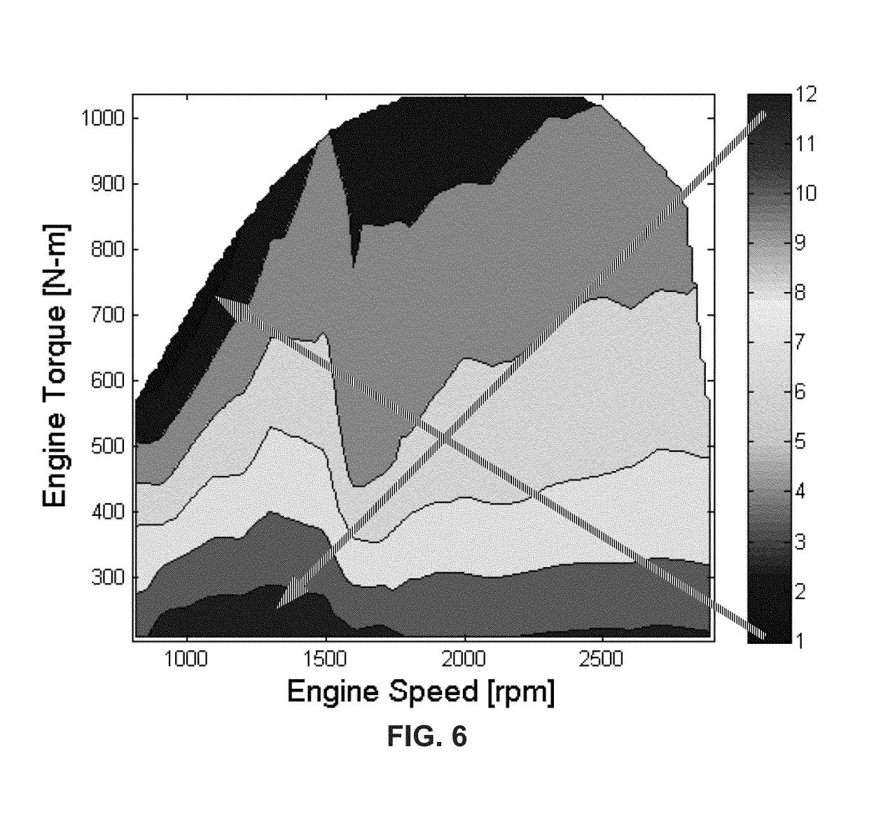

Utilizing knowledge of the physical system provided by experimental data collected over the operating range of the engine, maps of the parameters of the system can be generated including: kᵢₘ, kₑₘ, Wₑ, gₑₘ and δ. FIG. 3 shows the value of kᵢₘ calculated according to Eq. 15 for the collected experimental data. Similarly, FIG. 4 shows the value of kₑₘ calculated according to Eq. 16. FIG. 5 shows the value of Wₑ and FIG. 6 shows the value of gem over the operating range of the engine.

Utilizing FIGS. 3 and 5, the exponential convergence rate time constant,

$$τ = \frac{1}{2 {k}_{im} {W}_{e}} ,$$

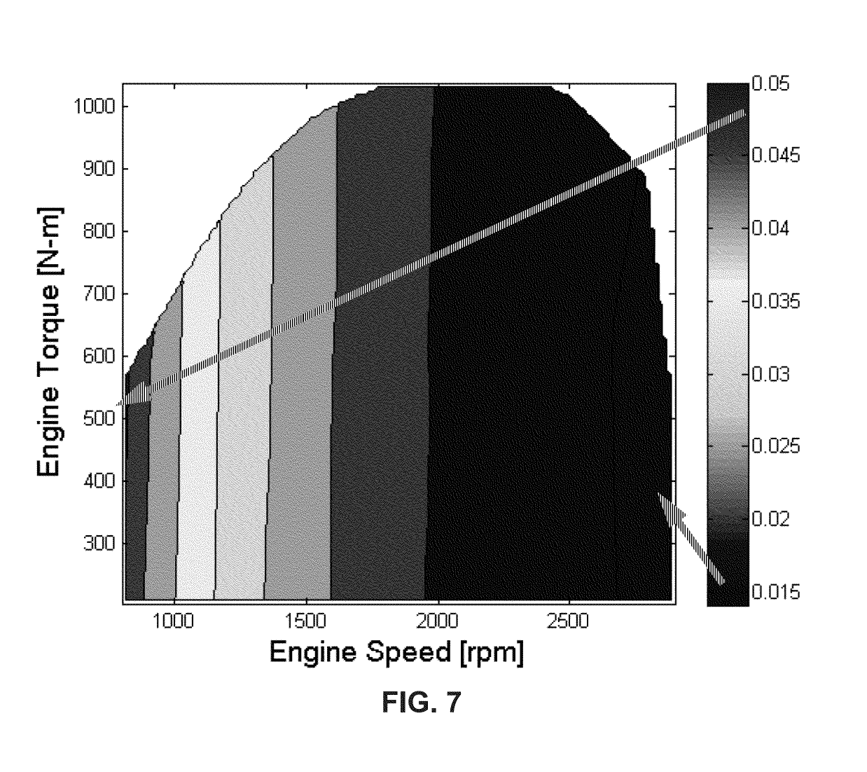

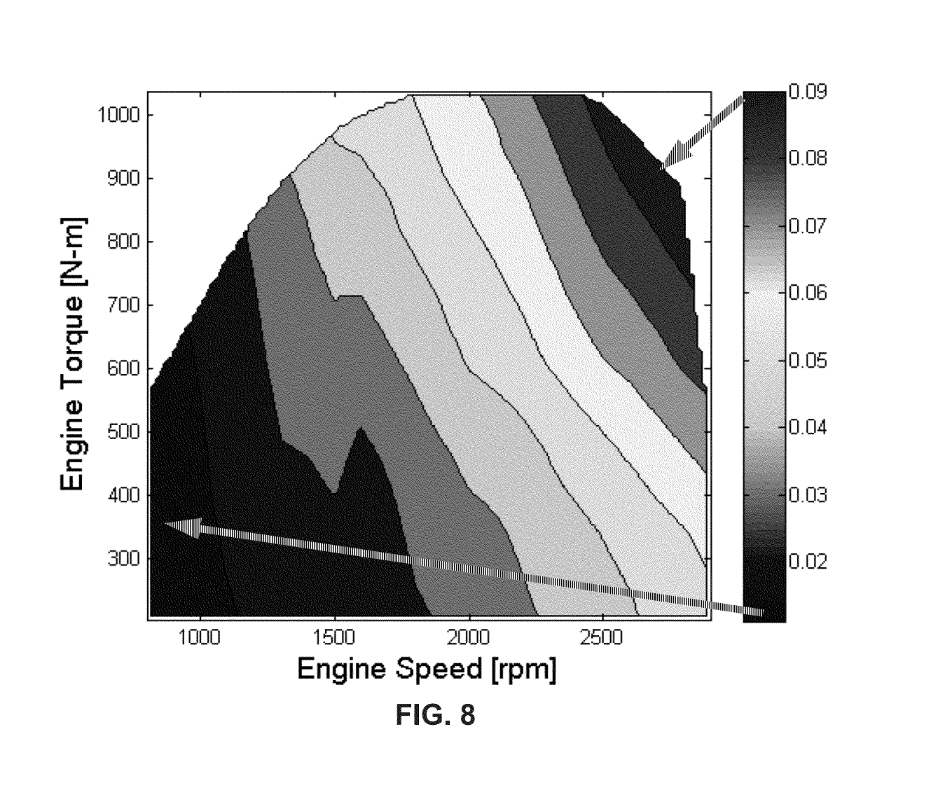

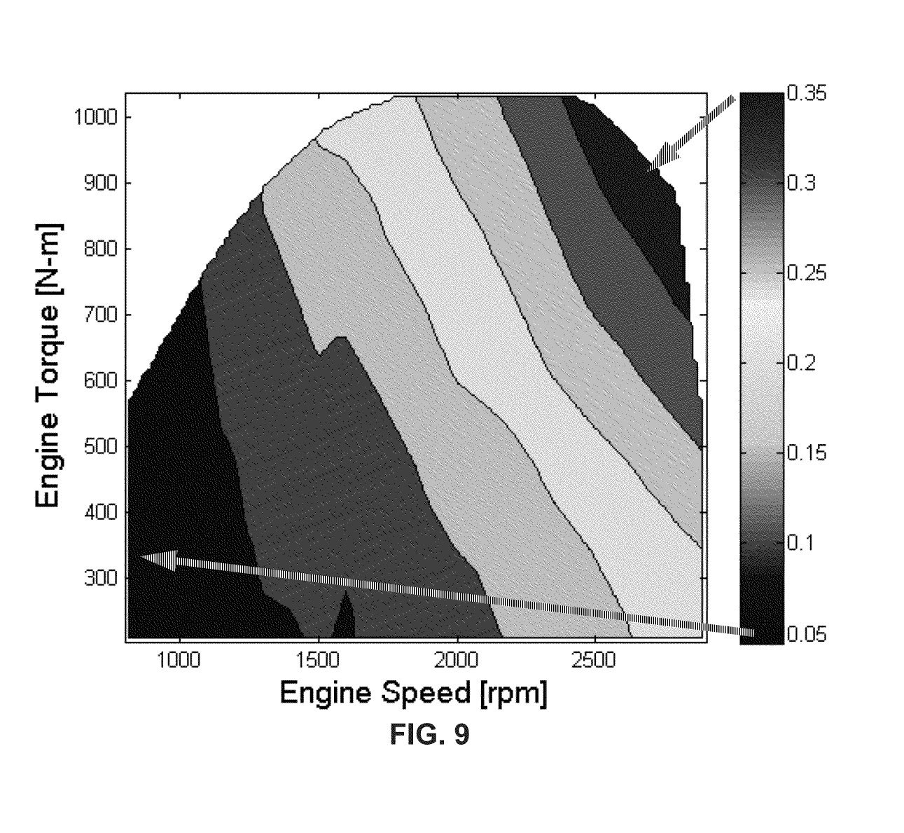

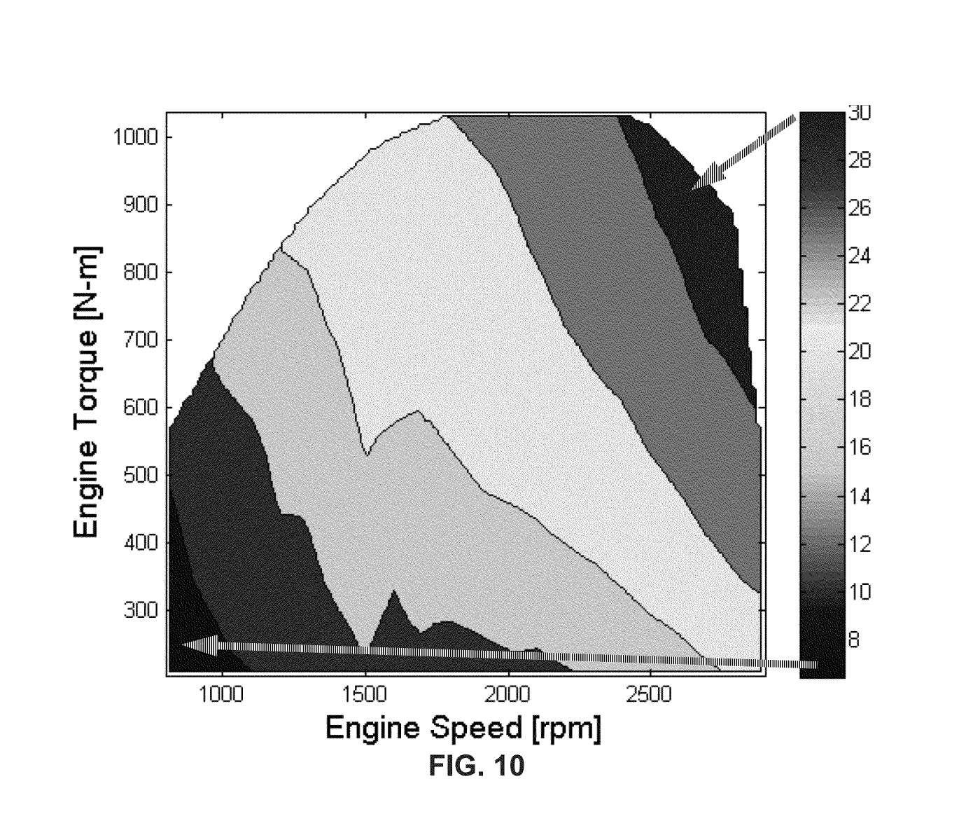

can be calculated and plotted as shown in FIG. 7. The largest time constants are located at low engine speed (due to the lower charge flow Wₑ through the engine). The desired gain l can be calculated utilizing knowledge of kₑₘ, shown in FIG. 4, and δ, shown in FIG. 8 (for the case when δ is 25% of the turbine flow, shown in FIG. 9). The combined plot of kₑₘδ is shown in FIG. 10. The largest value, of kₑₘδ from FIG. 10 is about 32.

Eq. 43 can be formulated as shown in Eq. 44 using values from FIG. 10 and the value of gₑₘ of 21% oxygen in ambient air. In one embodiment, an estimator gain of 1350 is selected.

$$l > \frac{32}{0.5} 21 - 32 = 1312 \qquad ( 44 )$$

The in-cylinder oxygen fraction estimator in some embodiments estimates oxygen fraction to within about 0.5% O₂ with exponential convergence with a time constant less than about 0.05 seconds (per FIG. 7) even in the presence of turbine flow errors of up to about 25%.

The CO₂ concentration in the intake manifold can be used to calculate the intake manifold oxygen fraction. In one series of data validations, the intake CO₂ concentration was collected with Cambustion NDIR Fast CO₂ analyzers as described in Section II. The Cambustion analyzers provide the fast response time useful for transient evaluation. A laboratory grade UEGO sensor in the exhaust pipe was utilized as a measurement of the oxygen fraction in the exhaust manifold.

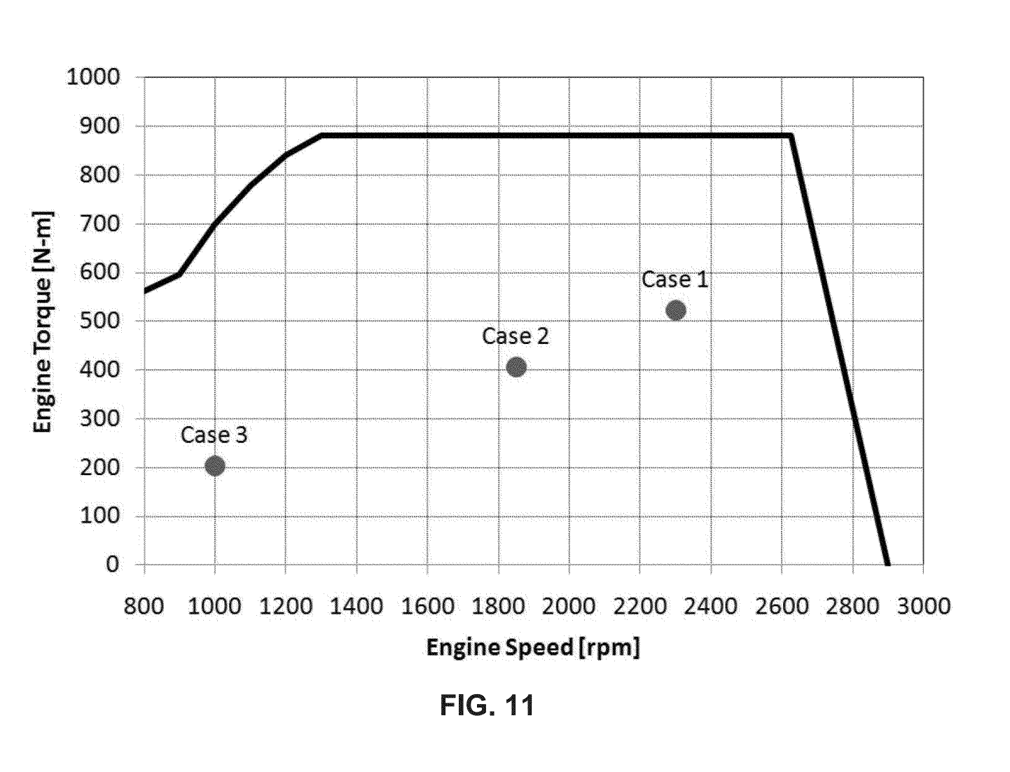

Experimental validation data was collected at three operating conditions, 2300 rpm and 522 N-m, 1850 rpm and 407 N-m, and 1000 rpm and 203 N-m as shown in FIG. 11. Transient step changes of the gas exchange actuators were performed to test the oxygen fraction estimator. The primary gas exchange actuators in the test bed include the EGR valve position, the VGT position and the intake valve closing (IVC) time.

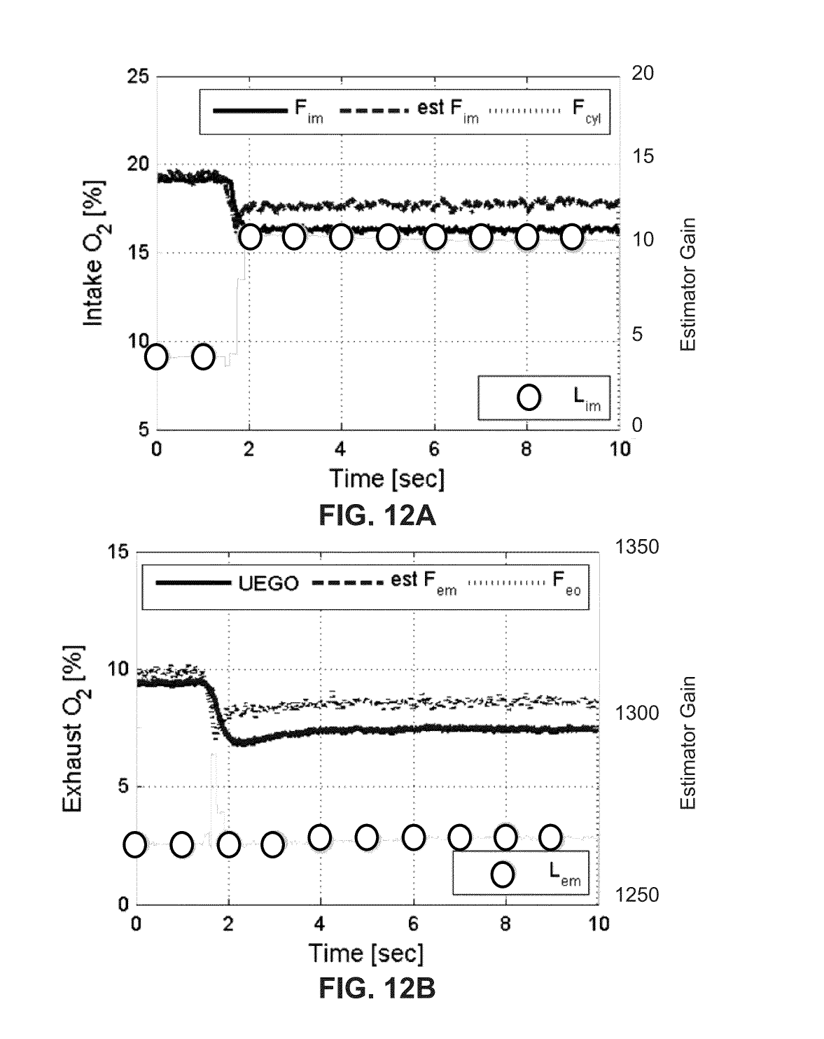

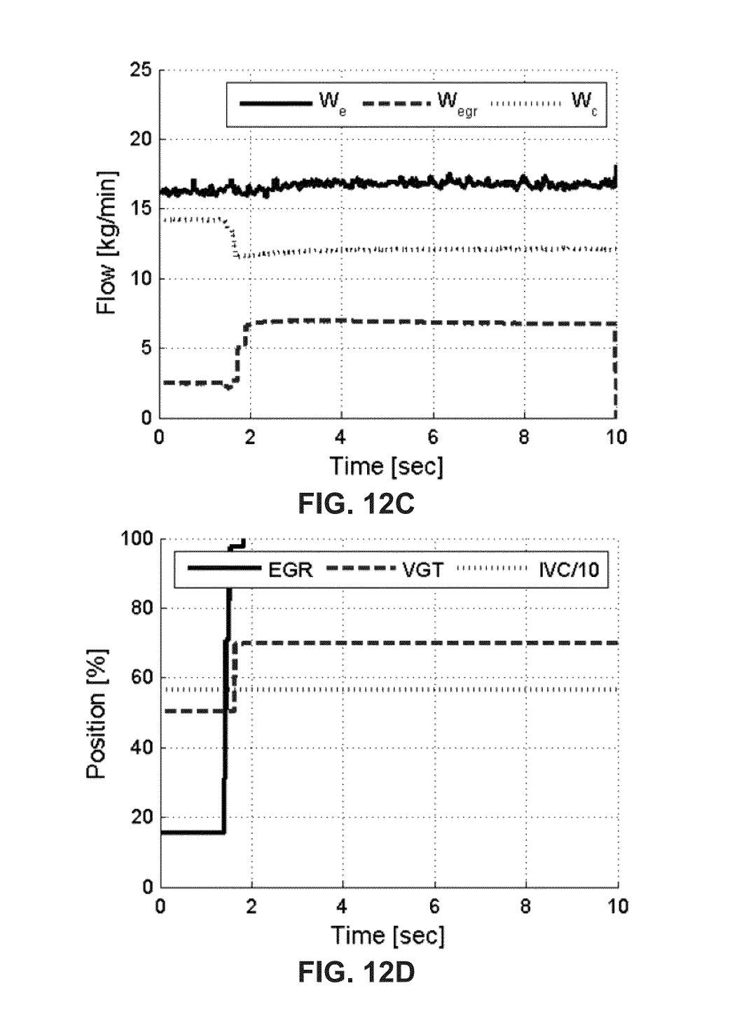

FIG. 12 illustrates an EGR and VGT step change at an engine operating condition of 2300 rpm and 522 N-m. The EGR valve position was stepped from 15% open to 100% open while the VGT position was stepped from 50% closed to 70% closed. The changes in both the EGR valve position and the VGT position will result in increased EGR flow leading to lower intake and exhaust manifold oxygen fractions. In this test, the IVC timing was held constant. In FIG. 12, the upper plot demonstrates the capability of the oxygen fraction estimator for the intake and exhaust manifolds, on the left and the right respectively. The lower left plot illustrates the flows for the intake manifold, measured W_{c} from the LFE, calculated Wₑ from Eq. 9 and estimated M_{egr} provided by the ECM. The lower right plot shows the actuator steps.

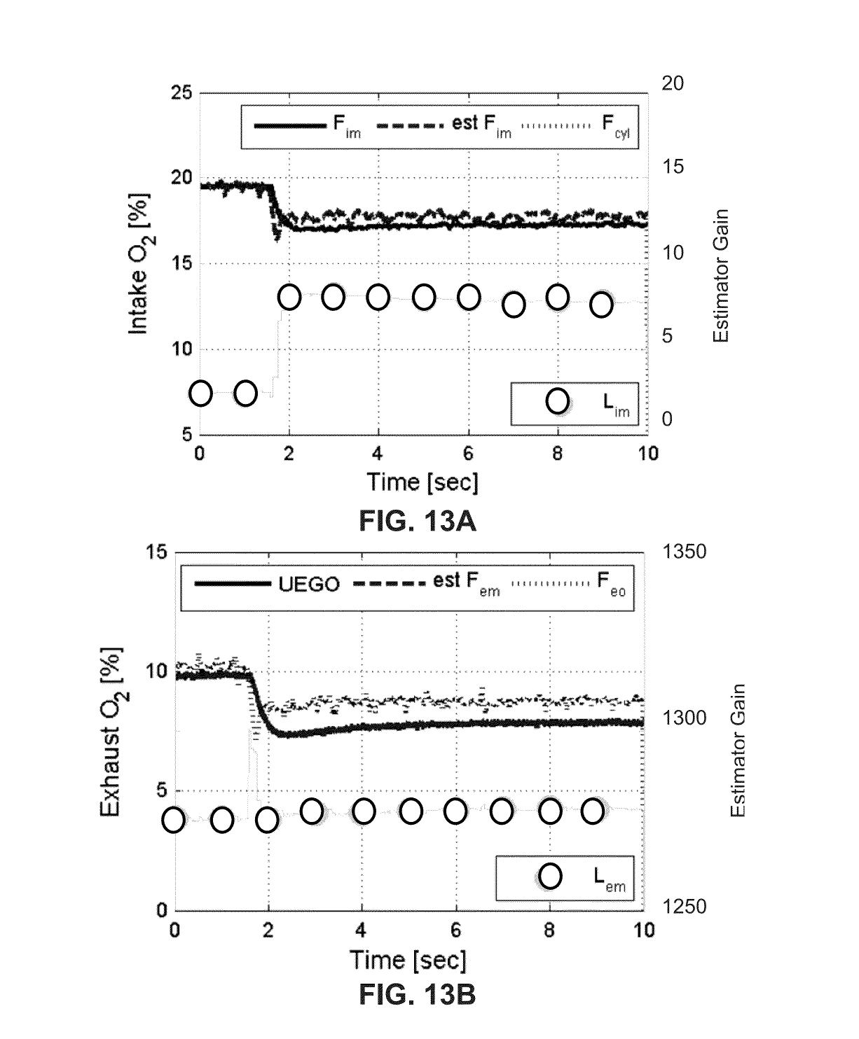

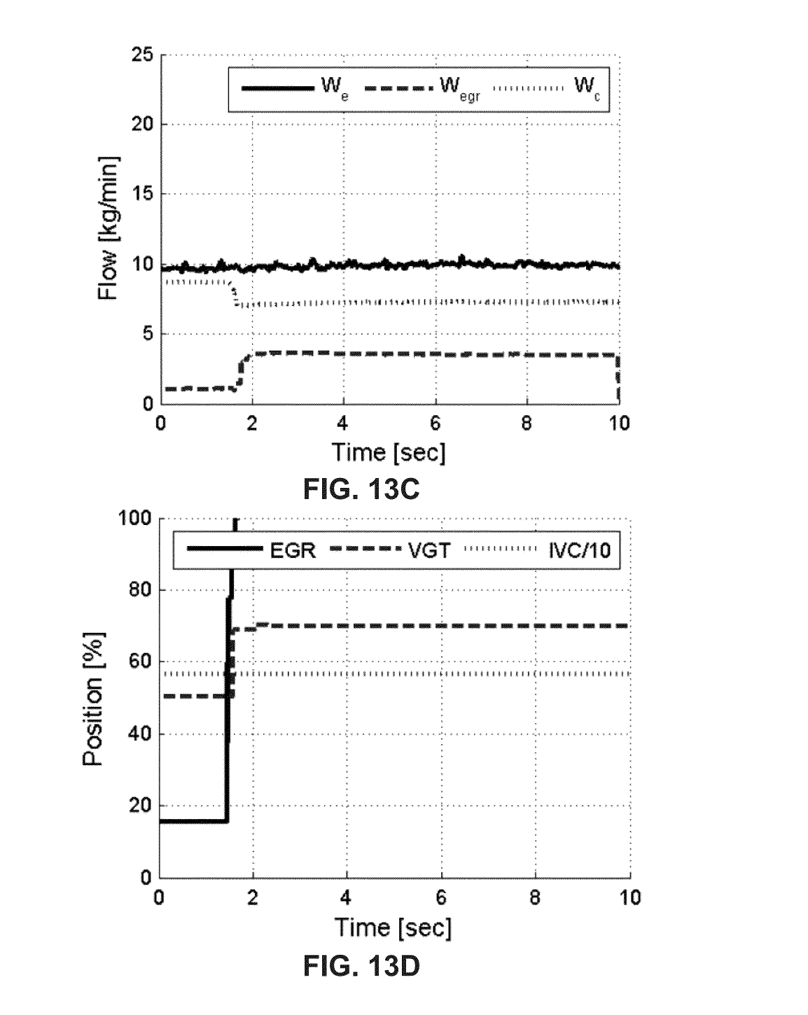

FIG. 13 illustrates an EGR and VGT step change at an engine operating condition of 1850 rpm and 407 N-m. The IVC timing was held constant.

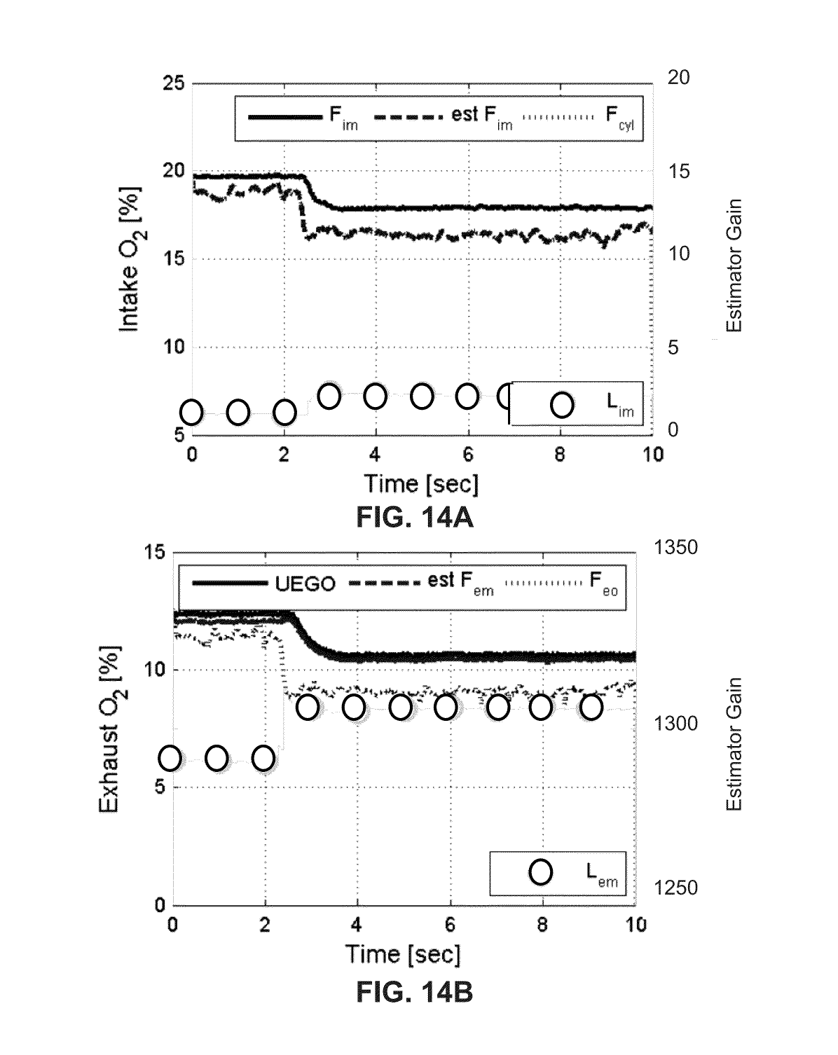

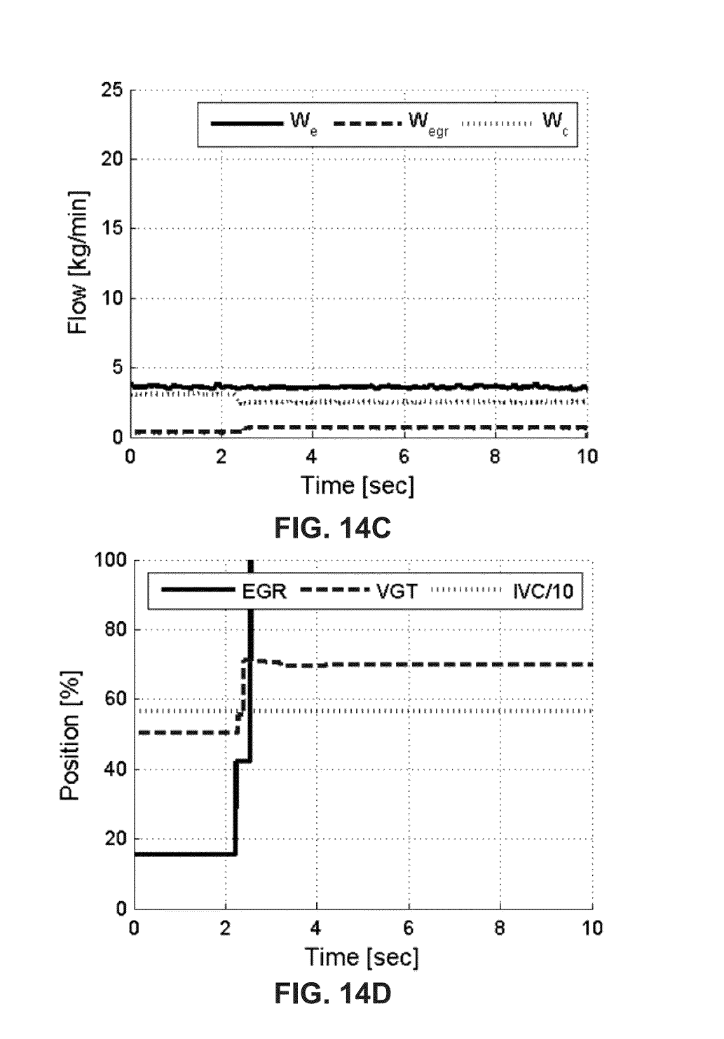

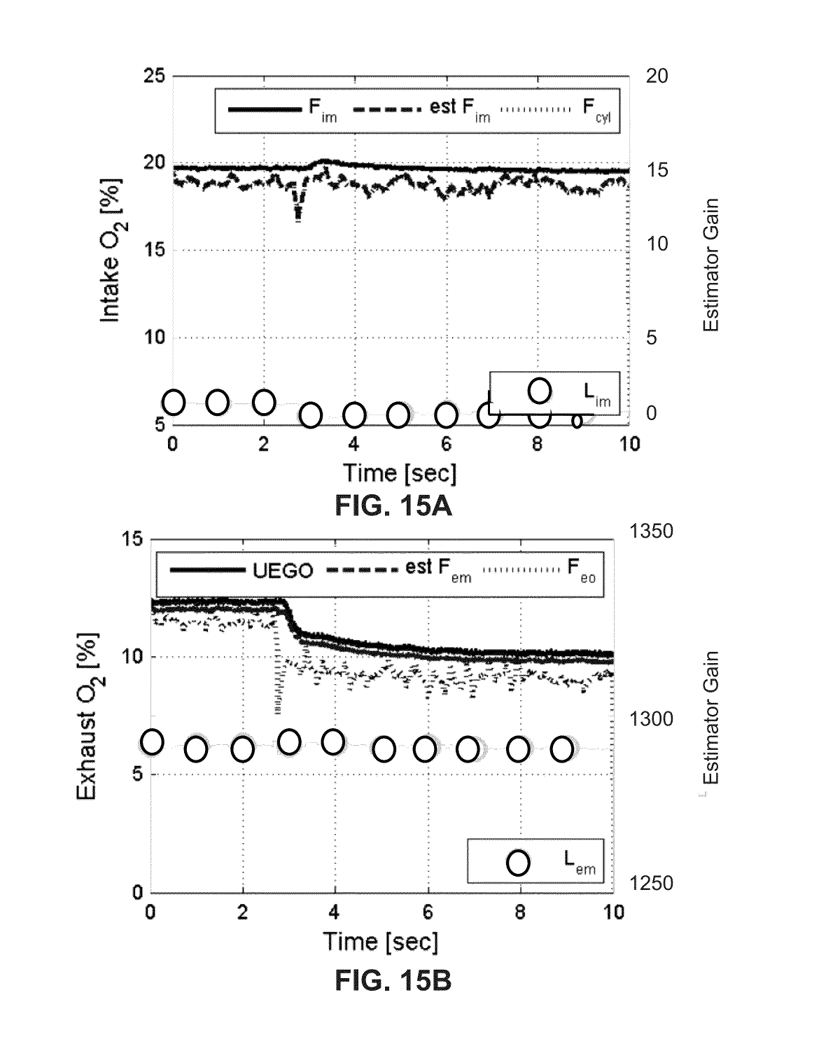

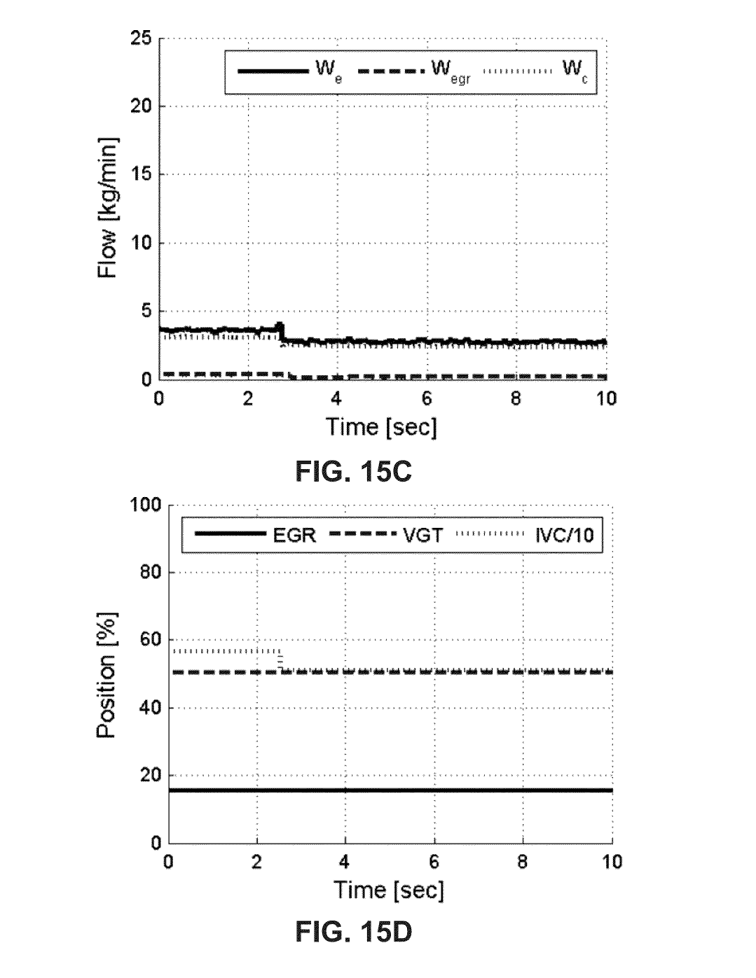

FIG. 14 illustrates an EGR and VGT step change at an engine operating condition of 1000 rpm and 203 N-m. The IVC timing was held constant. FIG. 15 illustrates an IVC step change at an engine operating condition of 1000 rpm and 203 N-m. The IVC timing was stepped from 565 crank angle degrees, the nominal timing, to 510 crank angle degrees, 55 degrees earlier. The EGR valve position and the VGT position were held constant. The IVC step resulted in a slight decrease in intake manifold oxygen fraction and a lower exhaust manifold oxygen fraction due to the lower charge flow through the engine at a constant fueling.

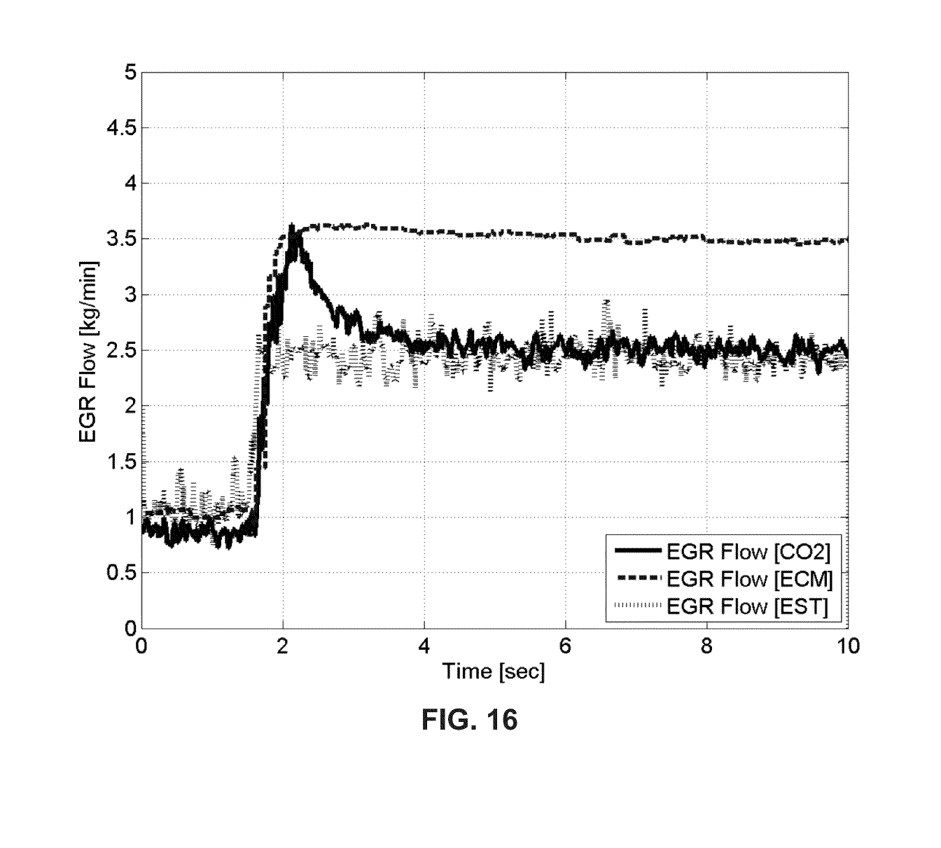

The estimator performance for intake oxygen fraction shown in FIGS. 12-15 contain a DC offset during some steady-state sections, particularly for Fᵢₘ estimates in FIGS. 12, 13, 14 and 15 and for Fₑₘ estimates in FIG. 15. These error estimates could result in in-cylinder oxygen fraction estimate, \hat{F}_{cyl} errors since in some embodiments it is directly calculated from \hat{F}ᵢₘ and \hat{F}ᵢₘ (per Eq. 21). Examining the dynamic Equations for the intake oxygen fraction, Eq. 1, shows the dependence of the estimator performance to the accuracy of the flow information. The EGR flow provided by the ECM is compared to the EGR flow calculated from CO₂ measurements and the LFE device in FIG. 16. In this case, an inaccuracy in the ECM EGR flow leads to an incorrect estimation of the intake manifold oxygen fraction. To improve the accuracy of the EGR flow, an EGR flow estimator is provided in some embodiments. The resulting EGR flow from the estimator is shown in FIG. 16 compared to the laboratory grade truth reference EGR flow (provided by CO₂ measurements in the intake and exhaust manifold, and an LFE fresh air flow measurement).

In some embodiments, a high-gain observer for EGR flow is used to augment the in-cylinder oxygen fraction estimation strategy 120. Consider a first-order dynamic system described by

ż=y=x (45)

where the parameters z and y are measured signals and x is the unknown input to be estimated. The variable x is not assumed to be slowly varying. The observer is described in terms of an auxiliary variable e satisfying

\dot{ε}≡−κε+κy+κ²z (46)

where K is a positive observer gain. Estimate of the unknown variable x is given by:

\hat{x}≡κz−ε (47)

It can be shown that \hat{x}→x for large gain K. Consider the error between \hat{x} and x:

e=\hat{x}−x=κz−ε−x (48)

Now assume that \dot{x} is bounded, as:

supₜ|\dot{x}(t)|≦b₁ (49)

for some positive constant b₁, there exists a transient bound for the estimation error:

$$\vert e ( t ) \vert \leq \sqrt{{( e ( 0 ) )}^{2} exp ( - κ t ) + \frac{{b}_{1}^{2}}{{κ}^{2}}} \qquad ( 50 )$$

This transient bound implies that by choosing a sufficiently large gain K, the upper bound on the estimation error (e(t)) and the convergence rate time constant

$$( {τ}_{e ( t )} = \frac{1}{K} )$$

can be made arbitrarily small. Hence, e in Eq. 48 tends to zero and \hat{x}→x. In this case, K=200 is selected to provide a time constant an order of magnitude faster than the in-cylinder oxygen fraction estimator, such that the time response of the EGR flow estimator may be neglected in some embodiments when considering the oxygen fraction dynamics

The high-gain observer 302 is now applied to estimation 114 of EGR flow, W_{egr} Consider intake manifold pressure, Pᵢₘ, dynamics, described by the commonly used manifold filling dynamics:

$${\dot{P}}_{im} = \frac{{γ}_{im} {R}_{im}}{{V}_{im}} [ {W}_{c} {T}_{cac} + {W}_{egr} {T}_{egr} - {W}_{e} {T}_{im} ] \qquad ( 51 )$$

Here, Wₑ and W_{c} are considered calculated values of charge flow into the cylinders and fresh air flow through the compressor and charge air cooler, respectively, and W_{egr} is EGR flow from the exhaust manifold, through the EGR cooler. T_{egr} is the gas temperature at the EGR cooler outlet, and T_{cac} is the temperature of the fresh air at the charge air cooler outlet. Both these temperatures are also measured. Rᵢₘ and Yᵢₘ are the gas constant and ratio of specific heats of the air in the intake manifold, respectively, both taken at ambient conditions. Vim is the volume of the intake manifold.

Charge flow, Wₑ, is calculated as described previously in Eq. 8. The Pᵢₘ dynamic equation, Eq. 51, can be written as:

$${\dot{P}}_{im} = \frac{{γ}_{im} {R}_{im}}{{V}_{im}} [ {W}_{c} {T}_{cac} - {W}_{e} {T}_{im} ] + \frac{{γ}_{im} {R}_{im}}{{V}_{im}} [ {W}_{egr} {T}_{egr} ] \qquad ( 52 )$$

The values z, y and x are chosen as follows:

$$\begin{matrix}z = {P}_{im} & ( 53 ) \\ y = \frac{{γ}_{im} {R}_{im}}{{V}_{im}} [ {W}_{c} {T}_{cac} - {W}_{e} {T}_{im} ] & ( 54 ) \\ x = \frac{{γ}_{im} {R}_{im}}{{V}_{im}} [ {W}_{egr} {T}_{egr} ] & ( 55 )\end{matrix}$$

With these assignments, it is seen that Eq. 52 becomes the first-order system described by Eq. 45. Wₑ can then combine Eqs. 45 and 47 with Eqs. 46 and 53 to derive an estimate for W_{egr}:

$$\hat{x} = κ {P}_{im} - ɛ = \frac{{γ}_{im} {R}_{im}}{{V}_{im}} [ {\hat{W}}_{egr} {T}_{egr} ] \qquad ( 56 )$$

with ε given by:

$$\dot{ɛ} = {κ}^{2} {P}_{im} - κ ɛ + κ \frac{{γ}_{im} {R}_{im}}{{V}_{im}} [ {W}_{c} {T}_{cac} - {W}_{e} {T}_{im} ] \qquad ( 57 )$$

Again, with the choices of z, y and x defined in Eq. 53, Eqs. 52, 56 and 57 correspond to Eqs. 45, 46 and 47. The estimated EGR flow is calculated in Eq. 58 and shown in FIG. 16 compared to the truth reference EGR flow at an engine operating condition at 1850 rpm and 407 N-m.

$${\hat{W}}_{egr} = \frac{{V}_{im} ( κ {P}_{im} - ɛ )}{{γ}_{im} {R}_{im} {T}_{egr}} \qquad ( 58 )$$

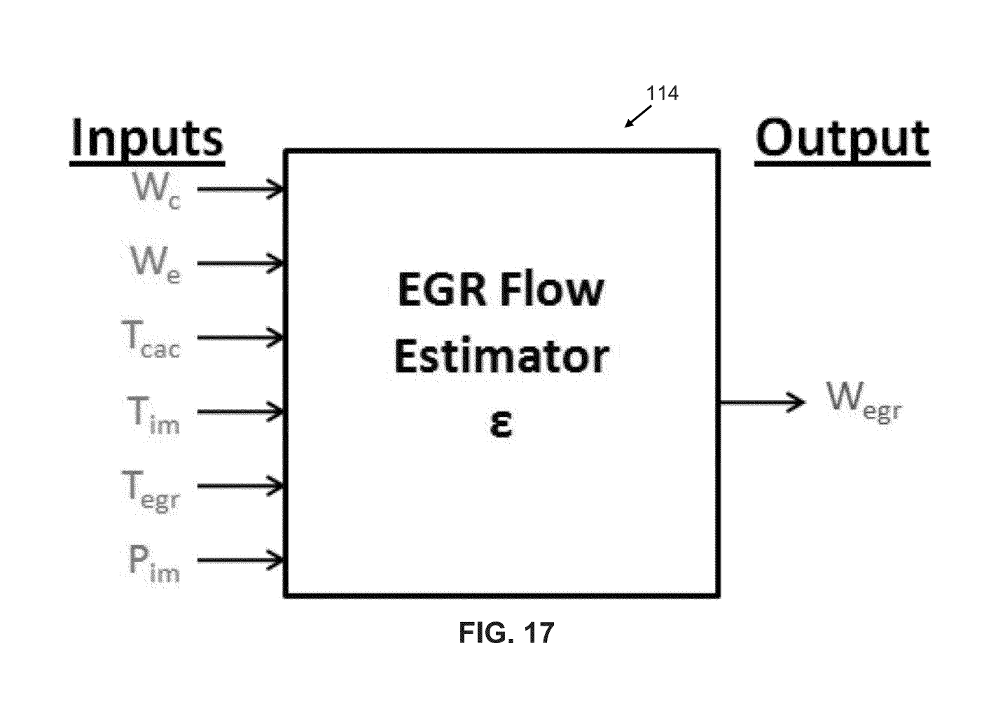

A block schematic of the EGR flow estimation scheme 114 is shown graphically is FIG. 17. Table III lists the source of the parameters utilized in the model in some embodiments.

TABLE III
EGR FLOW ESTIMATION MODEL PARAMETERS

| | |
|---|---|
| W_{c} | measured with LFE device |
| Wₑ | calculated from Eq. 9 |
| T_{cac} | measured with thermocouple |
| Tᵢₘ | measured with thermocouple |
| T_{egr} | measured with thermocouple |
| Pᵢₘ | measured by ECM |

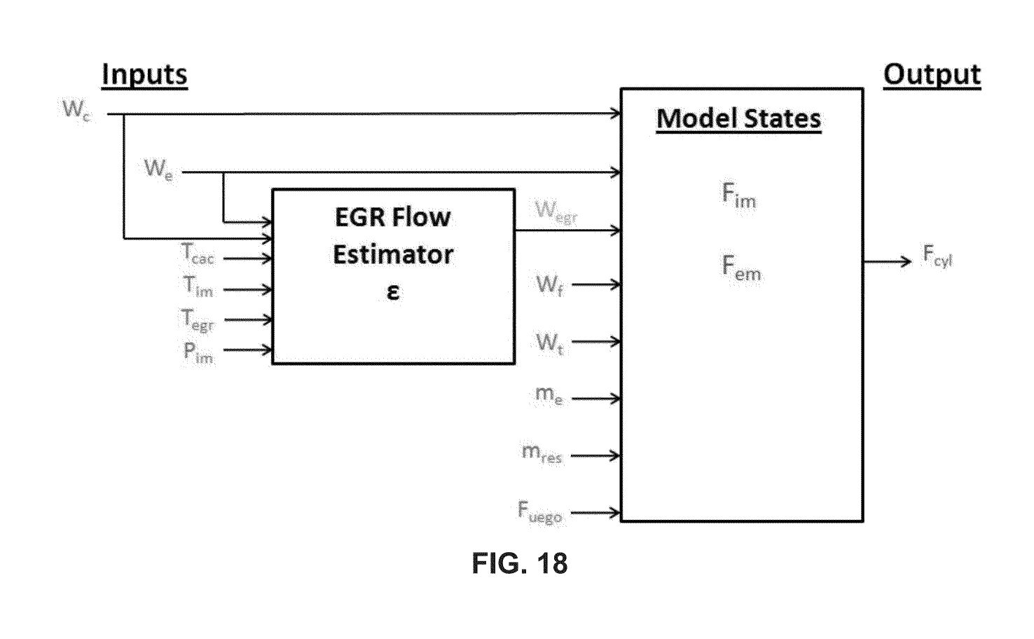

A block schematic of inputs, states and outputs of the in-cylinder oxygen fraction estimator coupled with the EGR flow estimator is shown graphically in FIG. 18. Table IV provides an updated listing of the O₂ estimator model parameters to reflect the usage of the EGR flow estimator.

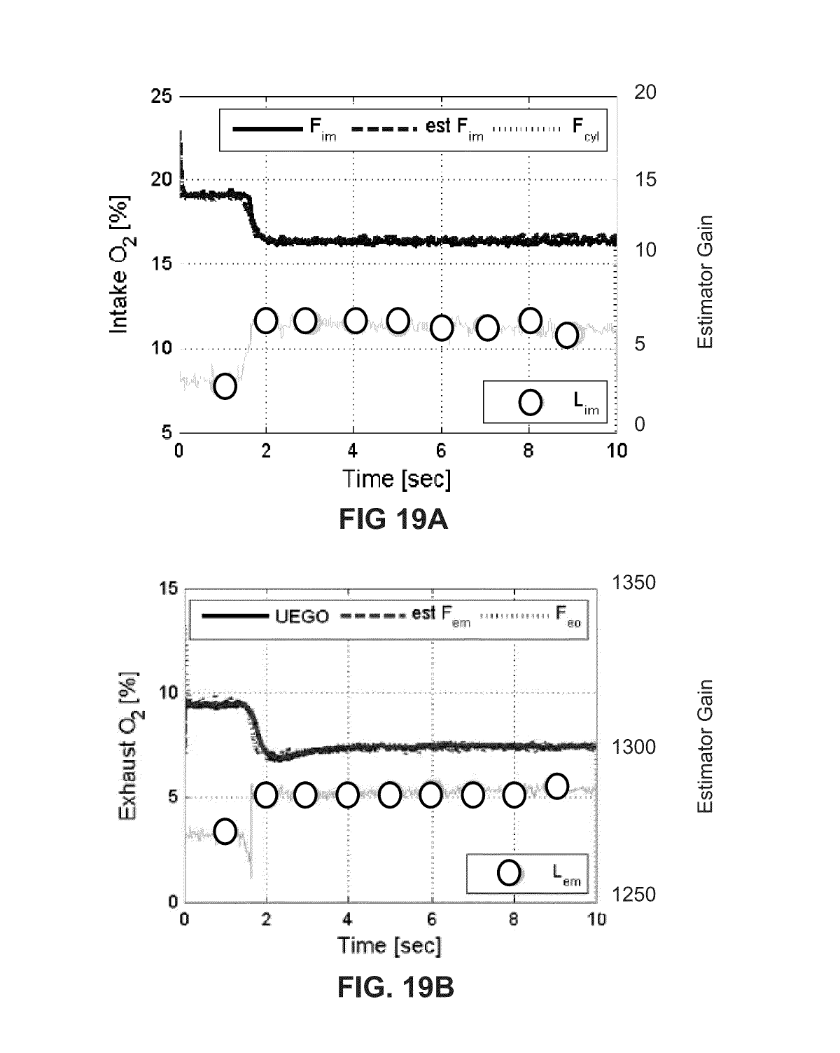

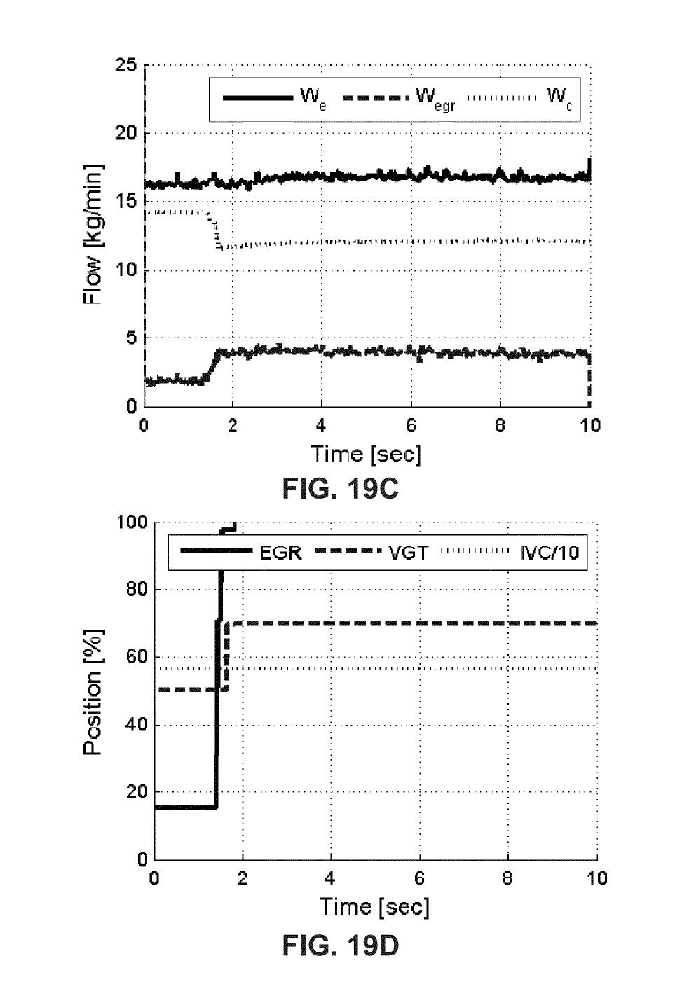

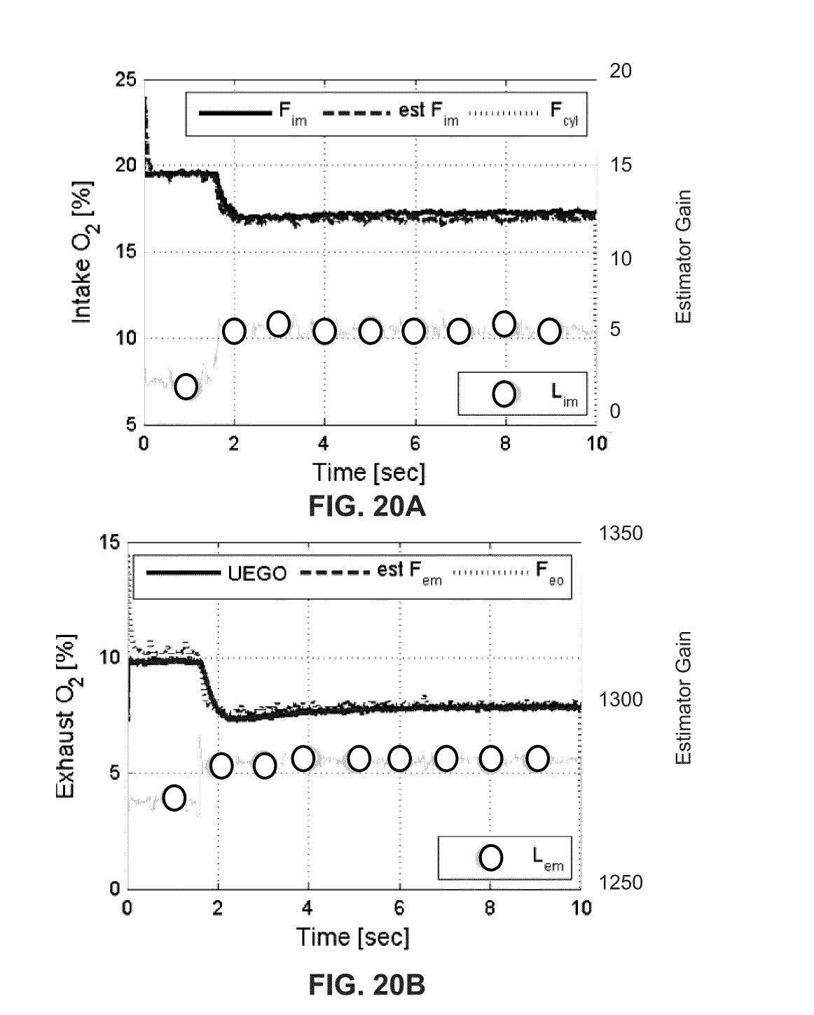

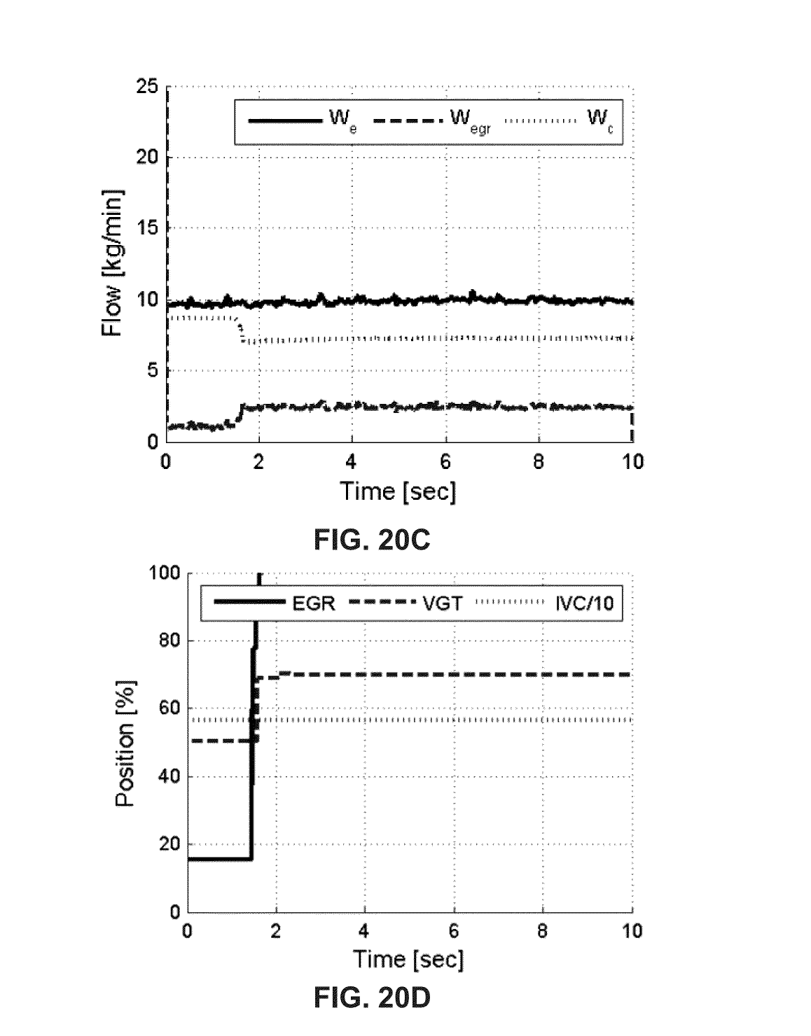

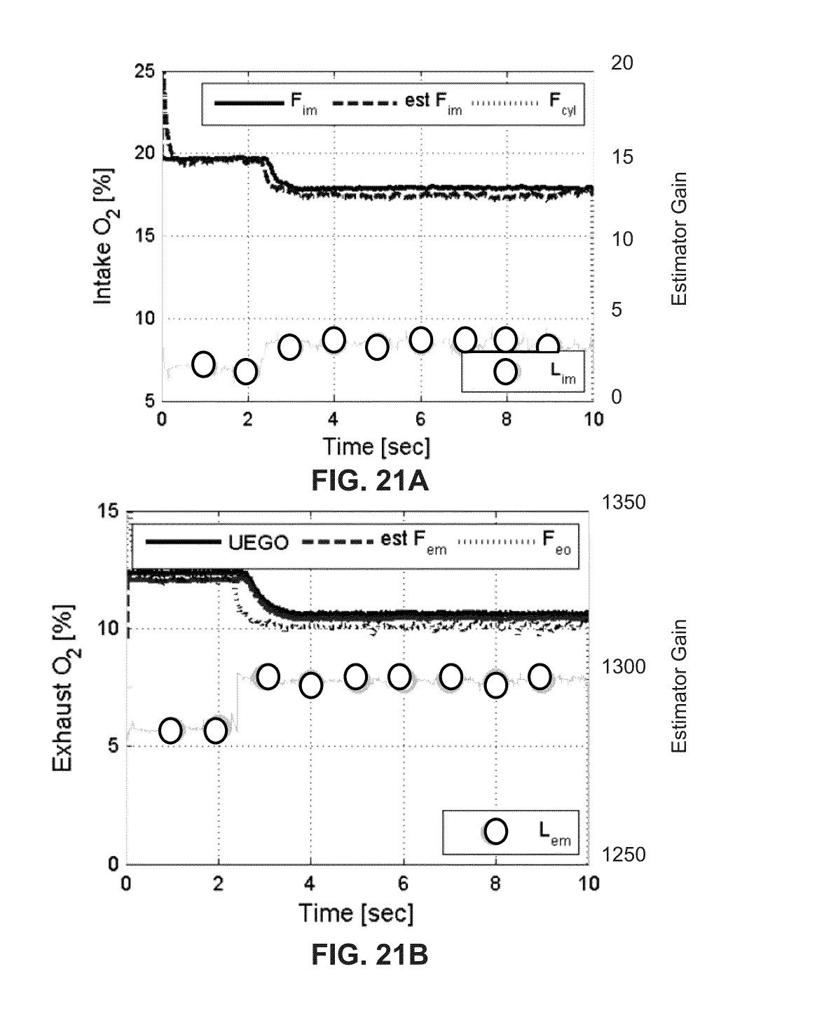

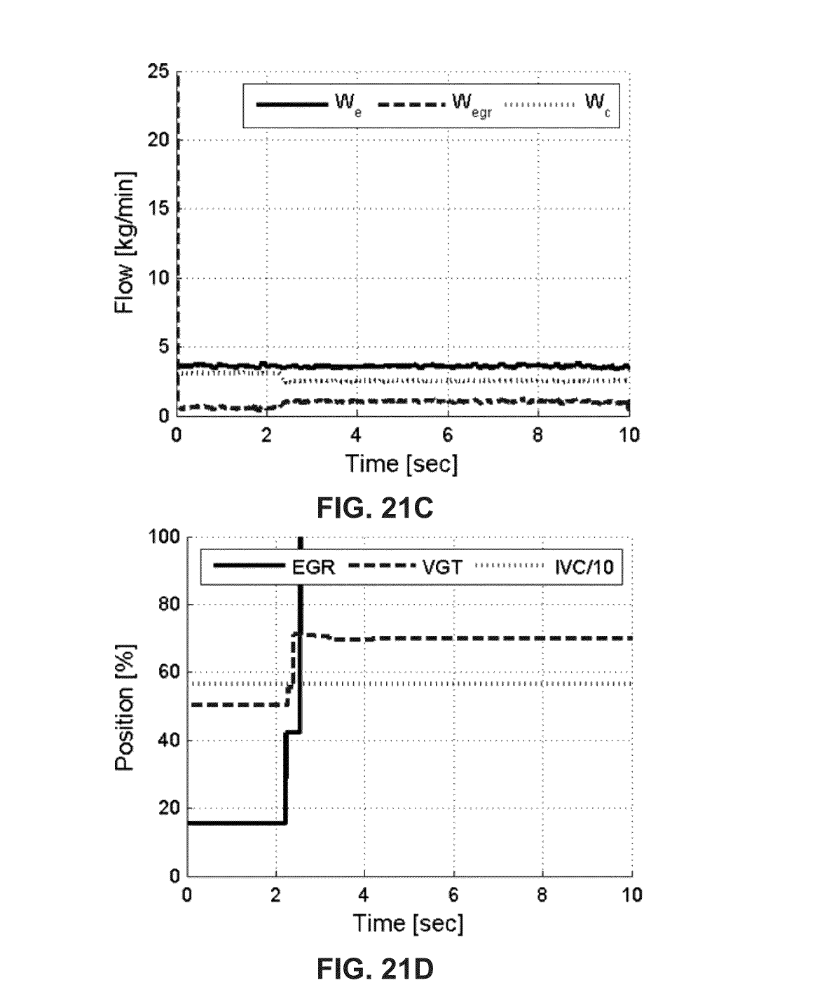

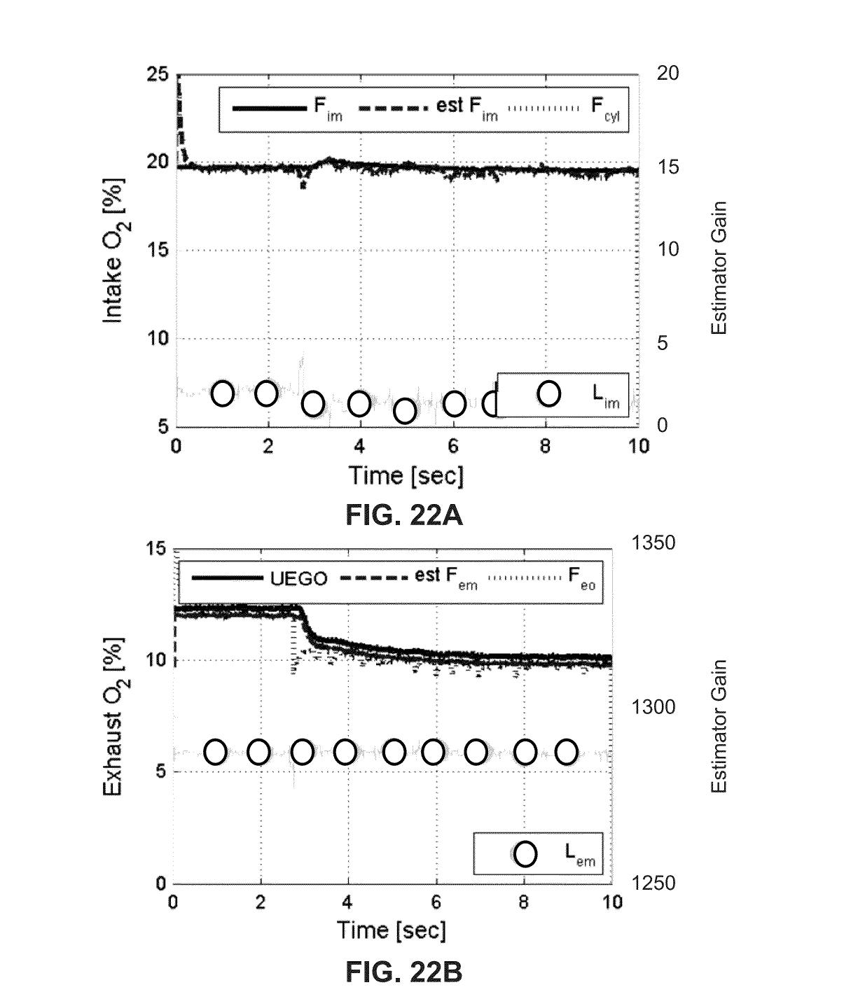

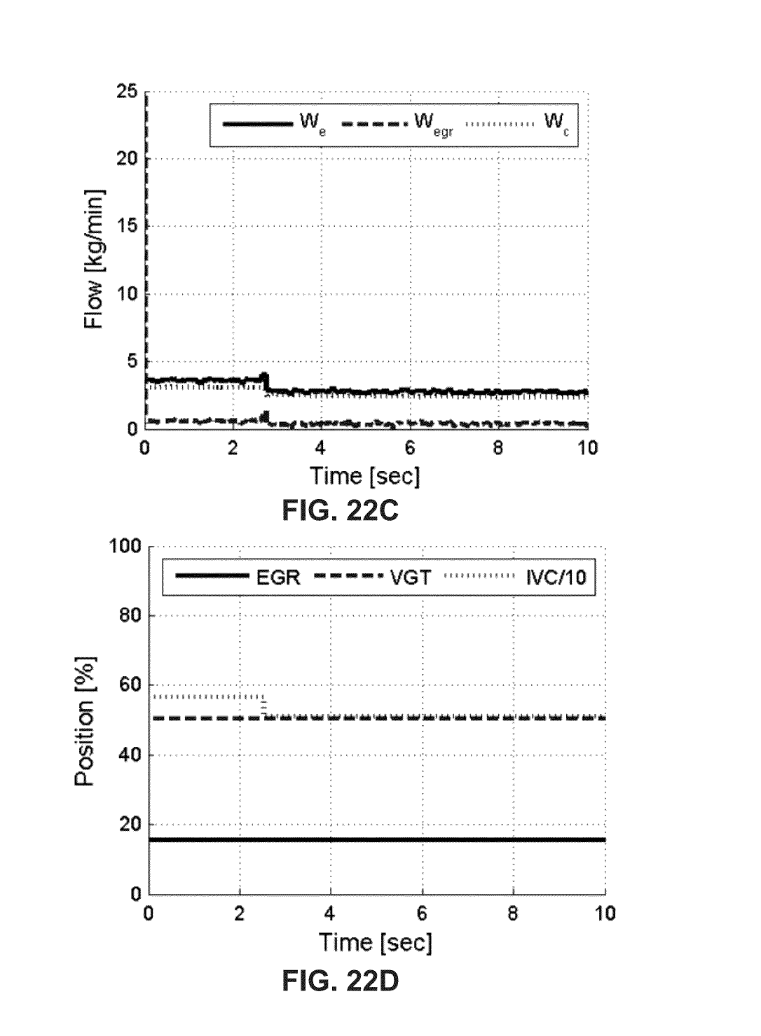

The oxygen fraction estimator 120 is now considered with the use of the estimated EGR flow from the high-gain observer. The experimental results for the improved oxygen fraction estimator are shown in FIGS. 19-22.

FIGS. 19-22 demonstrate the improved accuracy of the oxygen fraction estimator with the usage of the estimated.

TABLE IV
O2 ESTIMATOR MODEL PARAMETERS

| | |
|---|---|
| W_{c} | measured with LFE device |
| W_{egr} | calculated by high-gain observer |
| Wₑ | calculated from Eq. 9 |
| W_{f} | calculated by ECM |
| Wₜ | calculated from Eq. 12 |
| mₑ | calculated from Eq. 5 |
| mᵣₑₛ | calculated from Eq. 6 |
| F_{uego} | measured with UEGO sensor in exhaust pipe |
| Pᵢₘ | measured by ECM |

EGR flow. The oxygen fraction observer estimated the oxygen fractions in the manifolds to within 0.5% O₂. The demonstrated estimator convergence performance has a time constant less that 0.05 seconds.

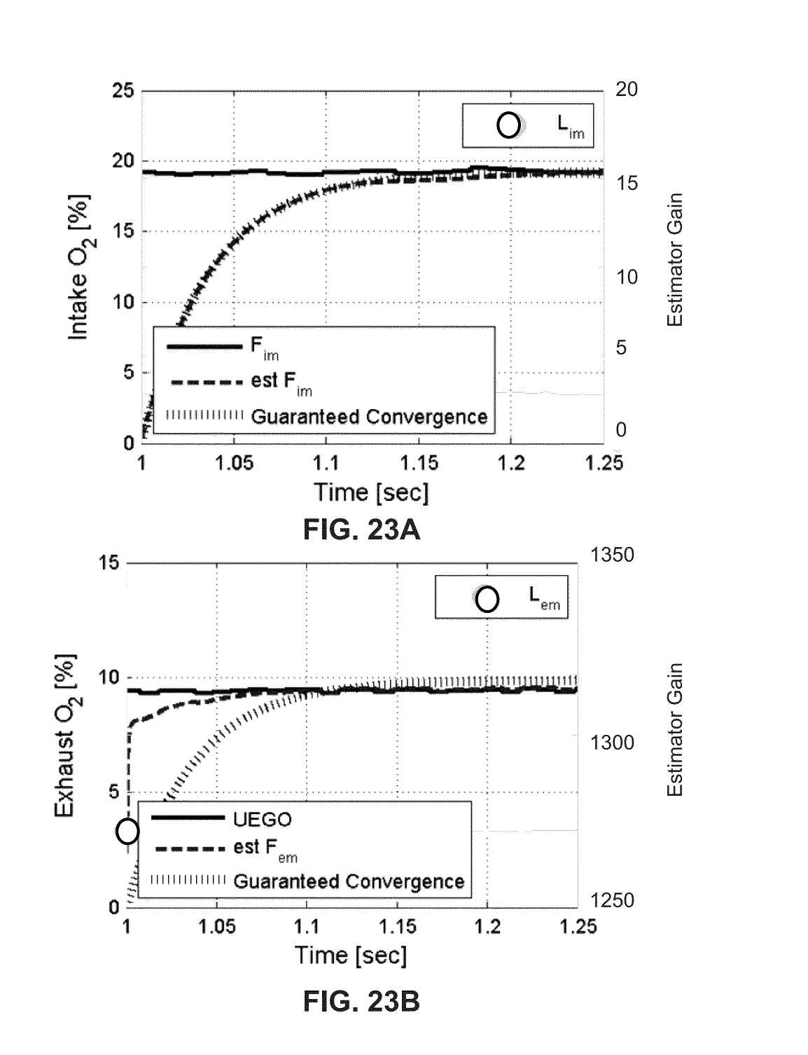

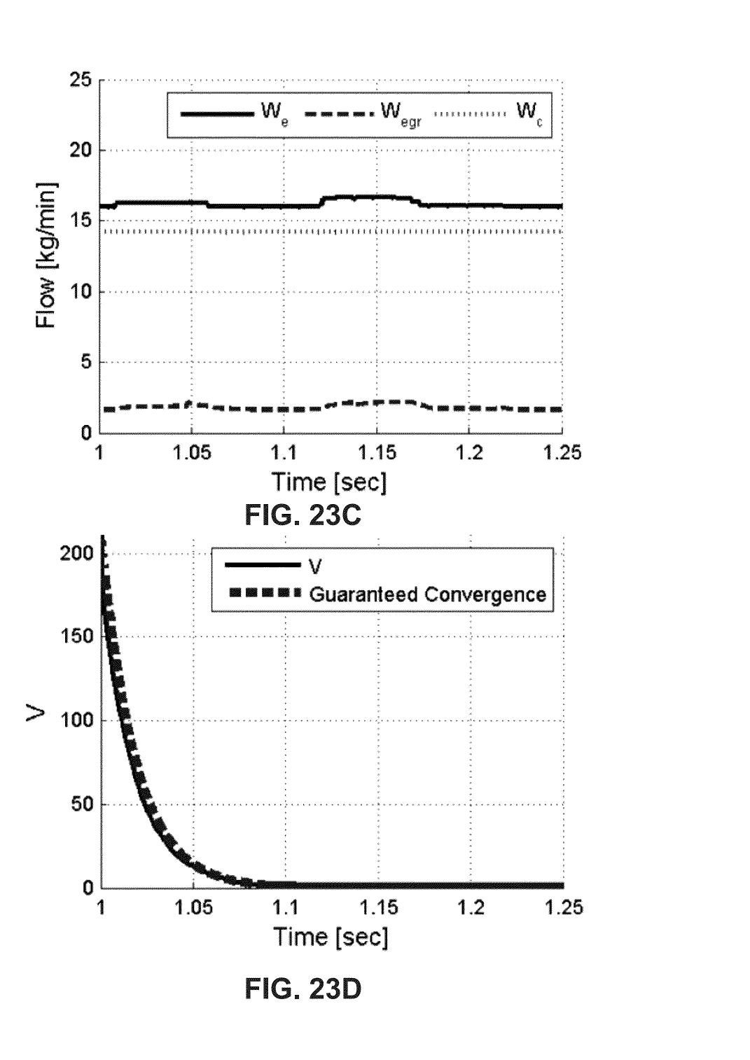

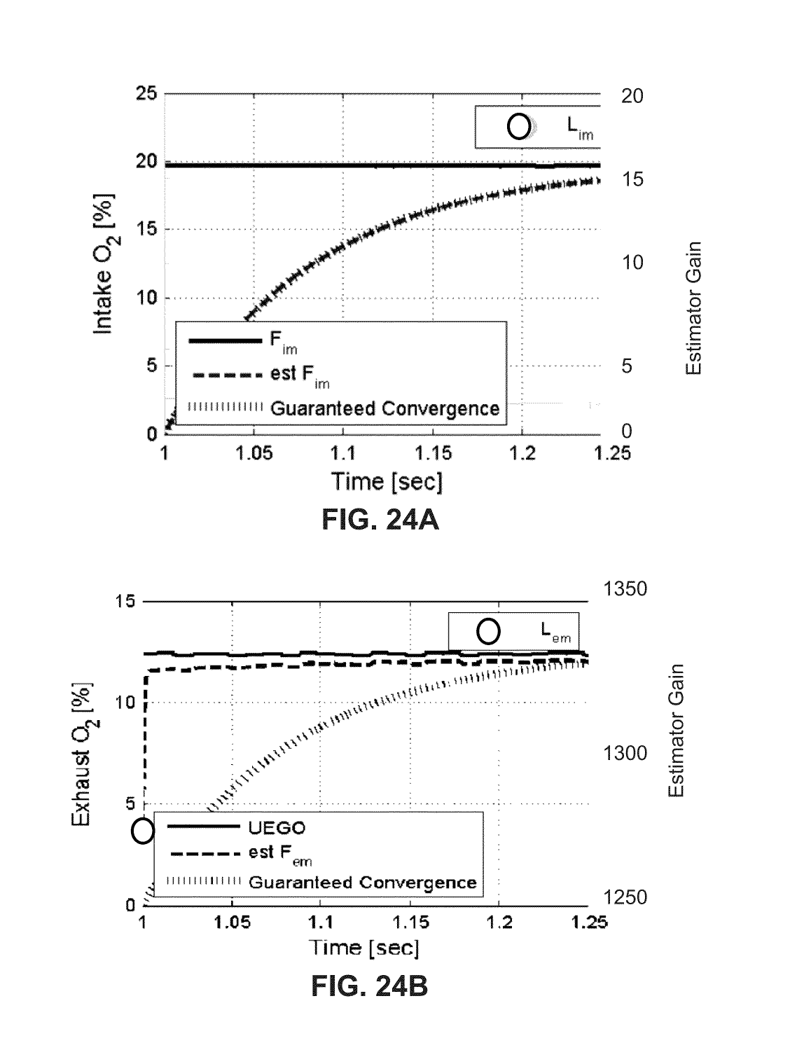

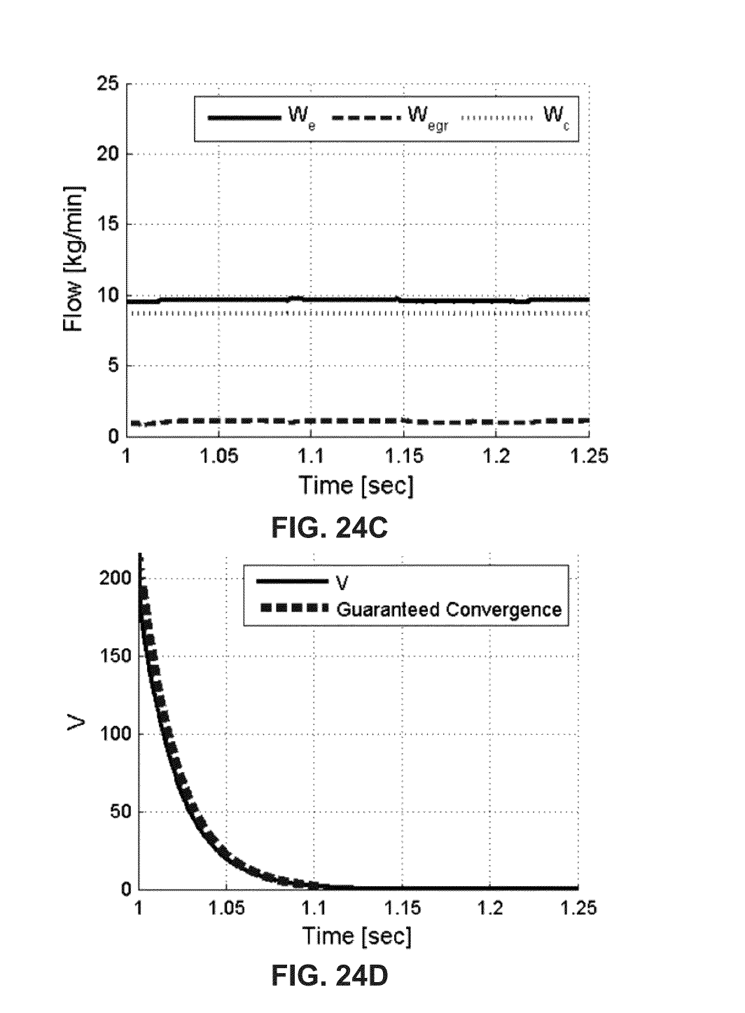

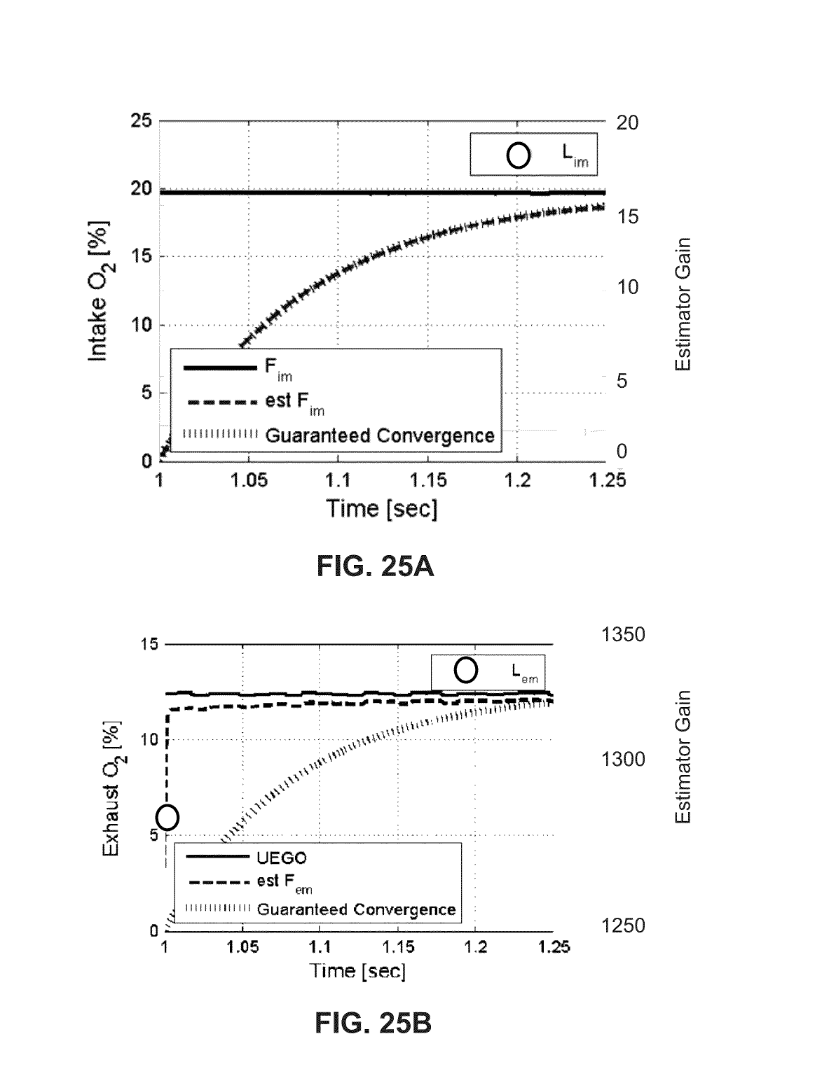

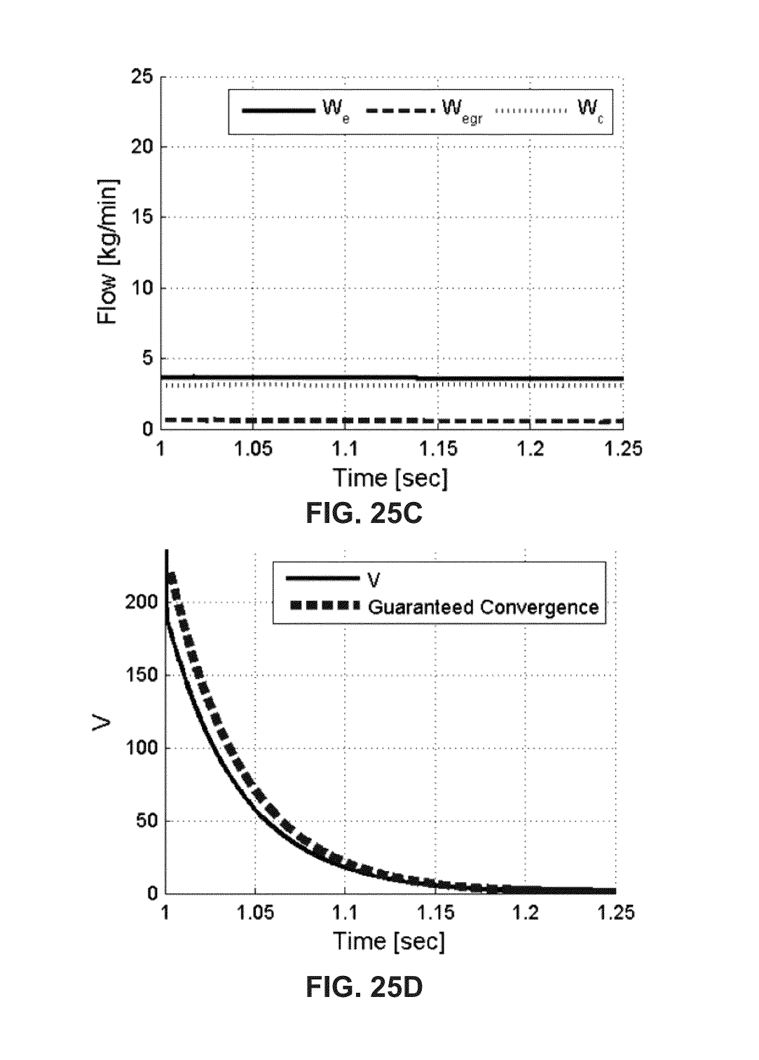

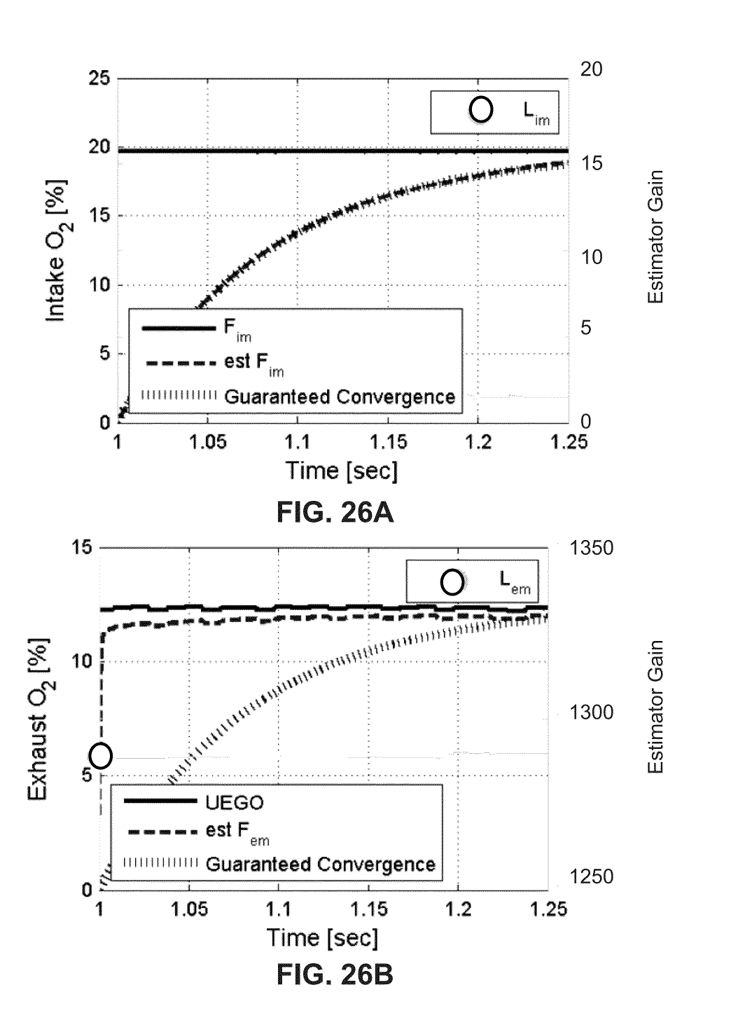

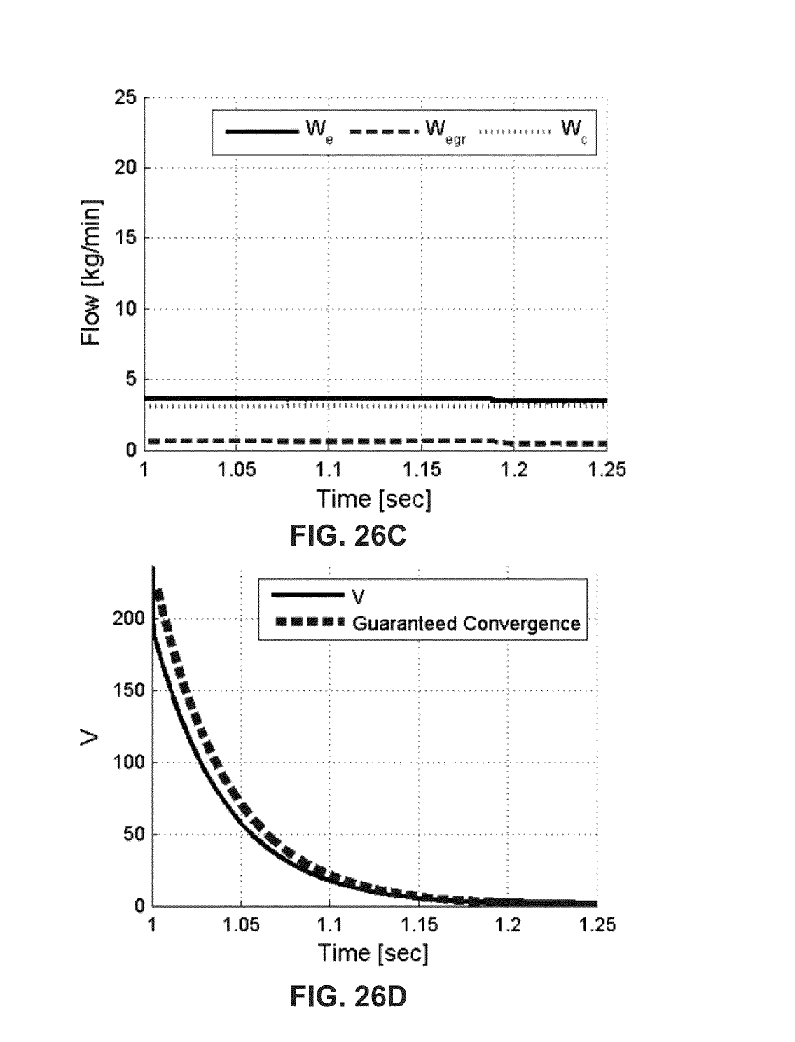

The exponential convergence rate of V, Eq. 33, for the oxygen fraction observer, pertains to the Lyapunov function, shown in Eq. 33, utilized during the stability analysis. In general terms, V is the average squared error of the manifold oxygen fraction estimates. Demonstration of the exponential convergence is provided by turning on the estimator at a specified time and comparing the convergence rate of V to the rate during the stability analysis, per Eq. 40, providing a worst-case scenario in terms of convergence time. For the experimental results shown previously, the estimator is activated at the 1 second mark and allowed to converge. The estimator performance is shown in FIGS. 23, 24, 25 and 26. In each case, the convergence of the estimator exceeds the exponential rate guaranteed by the stability analysis. The faster than exponential performance is expected as long as the flow uncertainty, 8, does not exceed 25% of the turbine flow, W₁, for the selected observer gain, l.

While the embodiments have been illustrated and described in detail in the drawings and foregoing description, the same is to be considered as illustrative and not restrictive in character, it being understood that only certain embodiments have been shown and described and that all changes and modifications that come within the spirit of some embodiments of the invention are desired to be protected.

What is claimed is:

1. An internal combustion engine, comprising:
a piston reciprocating within a cylinder and coacting with the cylinder to provide a combustion chamber;
an intake system providing a charge of gases to said chamber, said intake system including an actuatable variable intake valve;
an exhaust system collecting combustion products from said cylinder, said exhaust system including a wide band oxygen sensor providing a signal corresponding to the oxygen content of the combustion products; and
an electronic controller receiving the signal and operably connected to said intake system for actuation of said variable intake valve, said controller operating an algorithm to calculate a number corresponding to the oxygen content of the gases within the combustion chamber.

2. The engine of claim 1 wherein said intake valve is actuatable over a range, said algorithm includes data corresponding to the flow characteristics of the gas charge through said intake system over the range of actuation, and said algorithm number uses said data to calculate said number.

3. The engine of claim 1 which further comprises a turbocharger including a turbine and receiving combustion products from said exhaust system for driving said turbine, said oxygen sensor providing a signal corresponding to the oxygen content of the combustion products that drove said turbine.

4. The engine of claim 3 wherein said algorithm includes data corresponding to the flow characteristics of combustion products through said turbine, and said algorithm number uses said data to calculate said number.

5. The engine of claim 1 which further comprises an exhaust gas recirculation system receiving combustion products from said exhaust system and providing a portion of the received combustion products to said intake system.

6. The engine of claim 5 wherein said EGR system includes a cooler for reducing the temperature of the portion of combustion products provided to said intake system.

7. A method for controlling a diesel engine, comprising:
operating a diesel engine including an intake manifold and an actuatable variable intake valve providing a gaseous charge to a combustion chamber, an exhaust system receiving combusted mixture from the chamber, an electronic controller for controlling the engine and operably connected to the intake valve, and a wide band oxygen sensor;
measuring the oxygen content of the combusted mixture by the controller with the sensor;
recirculating a portion of the combusted mixture to the intake manifold;
actuating the intake valve by the controller;
estimating the intake flow characteristics of the intake manifold and the actuated intake valve by the controller; and
estimating the oxygen content of the gases within the combustion chamber by the controller with the estimated intake flow characteristics.

8. The method of claim 7 wherein the exhaust system includes an exhaust manifold having an internal volume, and which further comprises estimating the flow characteristics of the internal volume by the controller, wherein said estimating the oxygen content by the controller is with the estimated volume flow characteristics.

9. The method of claim 7 wherein said operating includes an exhaust manifold receiving combusted mixture from the engine and a turbocharger having an inlet receiving combusted mixture from the exhaust manifold and an outlet, and said measuring is of combusted mixture from the outlet.

10. The method of claim 7 wherein said operating includes an exhaust manifold receiving combusted mixture from the engine, and a turbocharger and an actuatable exhaust gas recirculation valve receiving exhaust from the exhaust manifold wherein said recirculating is through the recirculation valve, and which further comprises estimating the flow through the recirculated valve by the controller, wherein said estimating the oxygen content by the controller is with the estimated recirculated exhaust flow.

11. A method for controlling a diesel engine, comprising:
operating a diesel engine including an actuatable variable intake valve providing a gaseous charge to a combustion chamber, an exhaust manifold receiving combusted mixture from the chamber and providing exhaust, a variable nozzle turbocharger driven by exhaust from the exhaust manifold, an actuatable exhaust gas recirculation valve receiving exhaust from the manifold, an electronic controller for controlling the engine and operably connected to the intake valve and the recirculation valve, and a wide band oxygen sensor;
estimating the flow characteristics of the exhaust manifold by the controller;
measuring the oxygen content of the exhaust by the controller with the sensor;
actuating the recirculation valve by the controller;
recirculating exhaust from the actuated recirculation valve to the intake valve;
actuating the intake valve by the controller; and
estimating the oxygen content of the gases within the combustion chamber by the controller with the estimated exhaust manifold flow characteristics.

12. The method of claim 11 which further comprises estimating the flow of recirculated exhaust and said estimating the oxygen content is with the estimated recirculated flow.

13. The method of claim 11 wherein the variable nozzle turbocharger is actuatable over a range by the controller, and which further comprises actuating the variable nozzle by the controller.

14. The method of claim 11 wherein the turbocharger has an outlet for exhaust gas, and said measuring is of exhaust from the outlet.

15. The method of claim 11 wherein the recirculation valve is actuatable over a range by the controller.

16. The method of claim 11 wherein said operating includes an actuatable fuel system, and which further comprises actuating the fuel system by the controller to provide a quantity of fuel to the chamber and estimating the quantity of fuel by the controller, wherein said estimating the oxygen content is with the estimated fuel quantity.
